(19) United States
(12) Patent Application Publication
(10) Pub. No.: US 2015/0120388 A1
(43) Pub. Date: Apr. 30, 2015

(54) WORK AND QUALITY MANAGEMENT SYSTEM, DEVICE AND METHOD

(71) Applicant: Changi Airport Group (Singapore) Pte. Ltd., Changi Terminal 2 (SG)

(72) Inventors: Kiang Huat Tan, Singapore (SG); Hee Kwang Steve Lee, Signapore (SG); Chi Wing Joe Chiu, Singapore (SG); Sek Min Foo, Singapore (SG)

(21) Appl. No.: 14/389,122

(22) PCT Filed: Mar. 21, 2013
(86) PCT No.: PCT/IB2013/052233

§ 371 Date: Sep. 29, 2014

(30) Foreign Application Priority Data
Mar. 29, 2012 (IB) PCT/IB2012/051508
Apr. 5, 2012 (IB) PCT/IB2012/051680

(51) Int. Cl. G06Q 30/02; H04W 4/12; H04W 4/02; G06F 3/01

(52) U.S. Cl. CPC G06Q 30/0203; G06F 3/016; H04W 4/12; H04W 4/02
USPC 705/7.32

(57) ABSTRACT

The application provides management processes and a corresponding system for supporting facilities management services. The management processes comprise expense tracking, property information management, inventory procurement and withdrawal, fault reporting, work order creation, contract management, asset management and preventive maintenance processes. In one embodiment, the system is at least partially provided by a cloud computing system.

This application relates to a system, to a device, and to a method of work and to a quality management system.

Outsourcing of labor-intensive tasks is one way to reduce costs and to improve the quality in many business areas. When outsourcing customer sensitive services, such as the provision of public toilets, it is crucial to control care-fully the quality of the services provided in order to achieve an acceptable result for reasonable costs.

Customer satisfaction and attitude research surveys are common. Most surveys receive customer feedback either by requiring a customer to provide written responses to a survey questionnaire or by requiring the customer to respond orally to questions asked during a telephonic survey. Questionnaires or surveys requiring written responses are sent to a central location where the responses are read, transcribed, sorted, and manually forwarded to the relevant company.

There are computer aided customer satisfaction systems available but in practice, they are seldom used.

It is an object of the application to provide an improved feedback system.

The application provides a system for supporting outsource of facility management services to a third party. The system has a structure to allow for an online or an electronic feedback, which is quick and is immediate. This system can be used for collecting service feedback.

The system comprises at least one client terminal computer with a display device, with at least one corresponding tactile input device, and with a client wireless communication module. The tactile input device includes a touch screen, buttons, or tactile means that one must press or touch in order to provide an input.

The system also comprises an Inspection server computer with an Inspection server computer wireless communication module for communicating to the at least one client terminal computer, as well as with an Inspection server computer wireless phone module for communicating to at least one mobile computing device. The mobile computing device can include a smart phone or a wireless phone. The Inspection server computer wireless communication module and the Inspection server computer wireless phone module can be provided as one single module, which performs both functions of communication with the client terminal computer and with the mobile computing device. The Inspection server computer further comprises a predetermined set of inspection data lists.

The system also includes one or more mobile computing devices.

In use, the system provides a user feedback data acquisition mode, an alert mode, and a site inspection mode.

By providing the dedicated site inspection mode, it is possible to make sure that service providers do not minimize or reduce their expenditures for areas that they are responsible in such a manner that causes unacceptable customer service. In other words, the dedicated site inspection mode allows the service providers to manage their expenditure for their areas while preventing these areas from producing unacceptable customer service.

In the user feedback data acquisition mode, the client terminal computer provides a pre-determined set of user feedback messages on the display device. The user feedback messages serve as service comments for selecting by users. Upon receiving a user input into the tactile input device, the client terminal computer issues a pre-determined user feedback message over the client wireless communication module.

The pre-determined user feedback message is selected or is generated according to the user input. The client terminal computer is often equipped with a program for selecting the pre-determined user feedback message according to the user input, wherein the selection does not require manual intervention or input. Because of this, the issuing of the user feedback message can occur shortly after receiving the user input or feedback.

The Inspection server computer receives later the predetermined user feedback message from the client terminal computer over the Inspection server computer wireless communication module. The Inspection server computer then checks the received user feedback message as to whether the user feedback message indicates a user alert. The system enters into the alert mode, if the Inspection server computer identifies that the said user feedback message indicates a user alert.

In a generic sense, the Inspection server computer may receive other feedback messages beside the user alert. The Inspection server computer is usually equipped with a software program with corresponding data for differentiating the other feedback messages from the user alert.

In the alert mode, the Inspection server computer issues an alert message over the Inspection server computer wireless phone module to the mobile computing device. The server wireless phone module can include a 3G GMS network module or other communication network modules. The alert message is selected or is generated according to the user feedback message. The alert message acts for instructing a supervisor to proceed to the client terminal computer that has issued the respective user feedback message, which indicates a user alert.

Since the Inspection server computer can check the user feedback message electronically, the alert message can be issued quickly. This in turn allows the appropriate super-visor to be informed quickly of any service failure such that the service failure can be addressing soon. As one can see from this, this system allows for a fast response to a service failure.

In the inspection mode, the Inspection server computer selects one inspection data list from the set of inspection data lists. The inspection data list can be selected according to the user input.

The Inspection server computer then issues the selected inspection data list over the Inspection server computer wireless phone module to the appropriate mobile computing device. The inspection data list serves to instruct a supervisor to proceed to a particular location and to inspect a list of items shown in the inspection data list.

Upon arriving at the given location, the mobile computing device reads in pre-determined location information data that corresponds to the inspection data list from a device that is located at the said location. The reading of this predetermined location information data serves to indicate that the supervisor is physically present at the said location.

The mobile computing device then receives site inspection data from the supervisor.

The supervisor inspects the site or location according to items shown in the inspection data list and provides data of site inspection. The supervisor also fixes or corrects any service failure that he has found during the site inspection.

The mobile computing device then issues a site data message containing the received location information data and the received site inspection data to the Inspection server computer. The Inspection server computer later receives the said site data message containing the location information data and the site inspection data.

The Inspection server computer is provided by a cloud computing system. The cloud computing system comprises a network of computers. These computers provide a significant portion of the hardware and software support functions of the outsource facility management services.

The client terminal computer may need to perform only light functions, such as web browsing, since the rest of the functions are taken up by the cloud computing system.

The mobile computing device can act as a thick client, which provides web browsing to communicate and to pass messages between the mobile computing device and the Inspection server computer.

In one implementation, the mobile computing device has an Android application for downloading or transferring check lists from the Inspection server computer and for providing fault management functions. The check list acts as an inspection data list.

In use, when a service person arrives at a designate location, the service person downloads appropriate and relevant check lists from the Inspection server computer by using the mobile computing device, which is performing the Android application, to scan a barcode tag that is positioned at the location. The service person then indicates, in the Android application, tasks performed at the location as well as entering free text messages on the mobile computing device to elaborate on faults at the location and to explain what has been done to rectify the fault. The service person may also uses a picture taking function of the mobile computing device for taking a picture of the fault area before and after rectifying the fault and for sending the picture to the Inspection server computer.

In a general sense, the Android application can be replaced by other mobile phone applications.

The cloud computing system also allows additional computing resources to be easily added using techniques, such as load balancing, for handling surges in user demand.

The cloud computing system including two or more application servers acting as computer resources, and a load balancing device for receiving a plurality of computing request from client terminal computers and assigning the various computing requests to the application servers in accordance to the response times of the application servers. In other words, the application server with longer response time is assigned less computing requests for purpose of balancing load or burden of the computing requests among the application servers.

The application servers and the load balancing device often comprise Internet protocol ports for easy communication with each other.

Each application server having two or more segments of computer memory, wherein each segment of computer memory stores a software program for receiving a computing request from the load balancing device and for processing the computing request. In other words, the load balancing device can assign computer requests to the different computer memory segments.

This arrangement allows the application server to execute several programs, each program being similar or the same. The application server acts as several virtual application servers, wherein each virtual application server responds as a single server unit.

In one implementation, the cloud computing system is configured to have different servers at different locations with load balancing to cater for changes in demand. The load balancing allocates tasks or jobs for the different servers such that the loads of the servers are even. In other words, the servers have essentially the same computing load.

A surge in demand can occur when certain computer jobs that consume heavy computing resources are carried out at the same time, say in the morning and in the evening. In one example, the demand surge occurs when someone is doing daily inspection that coincides with monthly inspection and with many fault reporting. The demand surge can also occur when the cloud computing system is supporting different client terminal computers that are performing different workflows and processes. The demand surge can also occur when the mobile computing devices is searching past servicing history which takes up lots of computer processing time for crunching lots of historical data.

The cloud computing system can include multiple regional computing clusters that are set-up to support different regional computing needs. The cloud computing system enables the supporting network computers to be located in another location that is away from the client computers.

In one implementation of the system, an Instant Feedback System (IFS) is provided for a facility, such a public toilet. The IFS comprises a plurality of touch screen devices and an Inspection server computer.

In use, the Instant Feedback System (IFS) provides a mechanism to alert supervisors of the facility.

The touch screen devices receive touch inputs from users of the facility for allowing the users to provide comments or feedbacks of the facility. When the users provide a negative rating feedback to the touch screen devices, the touch screen then sends an alert message to the Inspection server computer.

The alert message can be related to cleanliness or to faults of the facility.

The Inspection server computer later sends a notification to the supervisors for acknowledgement and for follow up.

In an event, where the users feedback regarding cleanliness of the facility on the touch screen, the touch panel device would sends an alert message with a message code, which corresponds to the feedback, to the Inspection server computer.

Upon receiving the alert message, the Inspection server computer then selects a cleaning supervisor from a pre-assigned cleaning supervisor list and send a trigger alert with respective information, which includes location information and the feedback message code, to an inspection mobile device that is assigned to the selected cleaning supervisor for cleaning the facility.

The cleaning supervisor later receives notification of the trigger alert and then acknowledges the notification on the mobile computing device.

After a certain time, an escalation workflow is activated if the Inspection server computer does not receive an acknowledgment from the mobile computing device of the cleaning supervisor. The Inspection server computer sends a reminder message to the mobile computing device. If the Inspection server computer still does not receive any acknowledgement from the mobile computing device after a certain time, the Inspection server computer would escalate the alert by sending an alert message to a higher authority.

Upon completing the cleaning the facility, the supervisor then taps his staff pass on the touch panel device to indicate that the supervisor has responded to the reported feedback and to indicate time of completing the response to the feedback. The touch panel device later sends this information to the Inspection server computer.

In a general sense, the touch screen device is a form of the client terminal computer.

In short, the different modes of the system provide a structure for a quick service feedback and for a fast service inspection.

The application provides a system that is both economical and easy to use. By using a mobile computing device, such as a smart mobile phone, both for alerting a supervisor about an immediate and urgent customer complaint and for providing well-prepared site inspection lists, such an automated system is more easily accepted or received by users. Since most users are familiar with operating some forms of a mobile phone, these users would be able to adapt easily to the use of this said mobile computing device. This is especially so if the mobile computing device is also providing common telecommunication features, such as voice communication and SMS or MMS (Multimedia Messaging Service) data transmissions.

Optionally, the client terminal computer can also serve to provide the location information data. In the alert mode, the mobile computing device can read in a location information data at the particular client terminal computer that has issued the respective user feedback message, which indicates a user alert. The mobile computing device then issues a site data message containing the received location information data to the Inspection server computer. Later, the Inspection server computer receives the site data message containing the location information data. Rather than providing another device, this step uses the client terminal computer, which already exists, to provide the location information data.

In addition, the client terminal computer can identify the mobile computing device that is communicating with the client terminal computer. In the alert mode, the client terminal computer can also receive unique phone identity data relating to the mobile computing device that has received the alert message. The phone identity data serves as mobile computing device identity data and it acts to identify the mobile computing device. The client terminal computer then issues a data message containing the received unique phone identity data to the Inspection server computer. The Inspection server computer later receives the site data message containing the unique phone identity data.

The Inspection server computer can store the received data for evaluation purposes or for data-mining purposes. The evaluation may reveal trends of service failure, which can be used for resource management. The Inspection server computer can also forward the stored received data to a re-porting server computer for further evaluation purposes.

The mobile computing device can comprise a text data input device. The mobile computing device and the Inspection server computer wireless phone module each can comprise a GSM communication module. The GSM communication modules can provide GPRS, 3G, or 4G capabilities. Besides the GSM communication module, the client wireless communication module and the server computer wireless communication module each can also comprise a WLAN or other wireless communication module.

The alert message can also be sent in an SMS or a MMS format.

The client wireless communication module and the server computer wireless communication module each can comprise a GSM communication module. In a general sense, the client wireless communication module and the server wireless communication module each can also comprise a WLAN communication module or other wireless communication module.

Messages between the Inspection server computer and the client terminal computer can be transmitted in an SMS or a MMS format. All messages between communication modules can be sent as SMS or MMS messages or even as a simple push data packet, such as over FTP (File Transfer Protocol).

Data links between computers or servers can be provided as FTP data links for providing batch file operations. It is also possible to provide a direct data packet communication between applications on the various computers on any ISO level.

The inspection data list can comprise a checklist with blank data fields for receiving the site inspection data, wherein the site data message comprises the inspection data list and the site inspection data. The inspection data list provides a list of items for inspecting while the site inspection data provides a corresponding list of inspection results or information.

The mobile computing device can comprise a built-in camera being configured as a Bar code reader. The mobile computing device can also be used for transmitting photos to a superior data server, for instance for securing evidence, if a damage is detected.

The client terminal computer can comprise client memory unit for storing client data while the Inspection server computer can comprise client memory unit for storing server data. In the event of disruption of communication link between the client terminal computer and the Inspection server computer, these memory units can transfer their data to each other. These memory units then store and later transfer their data to each other after the communication link is established or restored. In other words, the memory units provide a means for the client terminal computer and the Inspection server computer to function until the communication link is restored.

The application also provides a client terminal computer with a display device, with one or more corresponding tactile input devices, with a client wireless communication module, and with a trigger port.

In particular, the tactile input device includes a touch screen, buttons, or tactile means that one must press or touch in order to provide an input. The client wireless communication module is intended for communication with a further computer device, which can be provided as an Inspection server computer or as a supervisor module server. The trigger port is used for receiving a trigger signal from a further electronic circuit.

In use, the client terminal computer provides a user feedback data acquisition mode and a wait mode.

In the wait mode, the client terminal computer is waiting for the trigger signal at the trigger port. Upon reception of a trigger signal, it changes into the user feedback data acquisition mode. The trigger signal serves to initiate the user feedback data acquisition mode.

In the user feedback data acquisition mode, the client terminal computer provides a pre-determined set of user feedback messages on the display device. The user feedback messages provide service comments for the user to select. Upon receiving a user input into the tactile input device, the client terminal computer issues a pre-determined user feedback message over the client wireless communication module and it changes into the wait mode. The user feedback message is generated or is selected according to the user input and it serves to provide feedback about services received by the user.

After lapsing a pre-determined wait time without receiving a user input into the tactile input device, the client terminal computer can change from the user feedback data acquisition mode into the wait mode. The client terminal computer deems that the user does not wish to an input if no user input is received within the pre-determined wait time. Changing into the wait mode then prevents other users, who are not the present actual user, from providing user input. In this manner, data integrity of the user input is preserved.

In the user feedback data acquisition mode, upon receiving a first user input into the tactile input device, the client terminal computer can provide a pre-determined second set of user feedback messages on the display device. The second set of user feedback messages can be selected according to the first user input. Upon receiving later a second user input into the tactile input device, the client terminal computer can change into the wait mode.

The structure provides two-level user service feedback, which allows for a detailed service feedback.

The application also provides a user feedback acquisition system. The system comprises the above client terminal computer and a motion sensor being electrically connected with a trigger port of the client terminal computer. When the motion sensor detects a user, the motion sensor actuates the trigger port of the client terminal computer to receive a service feedback from the user.

The application also provides a user feedback acquisition system. The system comprises the above client terminal computer and a purchase item bar code scanner being electrically connected with a trigger port of the client terminal computer. When the bar code scanner scans a purchase item, it also actuates the trigger port of the client terminal computer to receive a service feedback from the user.

The application also provides a user feedback acquisition system. The system comprises the above client terminal computer and a purchase item receipt printer being electrically connected with a trigger port of the client terminal computer. When the printer prints a receipt of a purchase, it also actuates the trigger port of the client terminal computer to receive a service feedback from the user.

The application also provides a user feedback acquisition system. The system comprises the above client terminal computer and a POS (point-of-sale) being connected electrically with a point-of-sale (POS) terminal device. The POS terminal device actuates the client terminal computer to receive a service feedback from a user.

The application provides a method for operating a facility management service. The method comprises a step of the facility management service providing a user feedback data acquisition service, an alert service, and a site inspection service.

Referring to the user feedback data acquisition service, it comprises a step of a client terminal computer providing a pre-determined set of user feedback messages on a display device. These feedback messages relates to service feedback or to service comments for selecting by a user.

Later, upon receiving a user input via a tactile input device of the client terminal computer relating to the feedback messages, the client terminal computer issues a pre-determined user feedback message to an Inspection server computer. The issued user feedback message is selected or is generated according to the user input.

The Inspection server computer later receives the transmitted pre-determined user feedback message from the client terminal computer over a server computer wireless communication module. The Inspection server computer then checks the user feedback message whether it indicates a user alert. The management service changes to provide the alert service, if the Inspection server computer identifies that the user feedback message indicates a user alert.

Referring to the alert service, it comprises a step of the Inspection server computer issuing an alert message over a server wireless phone module to a wireless mobile computing device. The alert message serves to instruct a supervisor to proceed to the client terminal computer that has issued the user feedback message, which indicates the user alert. The management service then changes to provide the inspection service.

Since a computer does the check of the user feedback message, the alert message can be selected or generated and be sent out quickly. This in turn allows for a quick response to any service failure.

Referring to the inspection service, it comprises a step of the Inspection server computer selecting one inspection data list from a set of inspection data lists and issuing the selected inspection data list over a communication module to the mobile computing device. The inspection data list can be selected according to the user input or to other means. The inspection data list serves to instruct the supervisor to proceed to a particular location and to perform site inspection according to items shown in the inspection data list.

Upon arriving at the location, the mobile computing device reads in a pre-determined location information data that corresponds to the inspection data list. This reading of the location information data acts to indicate or to confirm that the supervisor is present at the said location.

The mobile computing device later receives data of site inspection, which is performed by the supervisor according to the inspection data list. The supervisor also often corrects or fixes any service failure detected the site inspection.

The mobile computing device then issues a site data message containing the received location information data and the received site inspection data to the Inspection server computer. The site data message serves as a report of the site inspection. The Inspection server computer afterward receives the transmitted site data message that contains the location information data and the site inspection data.

The inspection service can serve to initiate a site inspection of a particular location in which a user indicates the location has a service failure.

The management service then changes to provide the user feedback data acquisition service.

In a general sense, the inspection service can be initiated according a pre-determined inspection schedule while an immediate urgent inspection service can also be triggered by the alert service.

The inspection service is provided by a cloud computing system. The cloud computing system allows additional computing resources to be easily added using techniques, such as load balancing, for handling surges in user demand.

In summary, the method allows for a service feedback shortly after the service is provided to a user. It also allows for a fast generation of an alert in the event of a service failure.

The inspection service can be performed a contractor, using a checklist and information that is being sent to the contractor from the Inspection server computer.

The inspection service can also be activated for rectifying a faulty item. A cleaner can detect the faculty item, which can be a wash basin tap or a toilet bowl. The cleaner, who do not have an inspection mobile computing device, can then feedback this finding by tapping his staff pass on a touch panel device that is located nearby. The cleaner then selects a fault from a list of common faults, which is displayed on the touch panel device and inputs the selection to the touch panel device.

The touch panel device then sends the fault information and the staff pass information to a first server. The first server afterward redirects this information to an Inspection server computer, wherein the Inspection server computer sends an alert is sent to a mobile computing device of a pre-assigned maintenance person, who is responsible for that area.

The maintenance person later acknowledges using the mobile computing device and proceeds to the reported area for service recovery. The Inspection server computer performs an escalation workflow if the Inspection server computer does not receive an acknowledgment from the mobile computing device after a certain time. The escalation workflow includes a step of the Inspection server computer sending a reminder message to the mobile computing device. If the Inspection server computer still does not receive any acknowledgement from the mobile computing device, the Inspection server computer then send an alert message to the next higher authority.

Upon arriving at the location, the maintenance person then uses the mobile computing device to scan a barcode tag that is positioned at the location. The mobile computing device later sends an arrival message with the barcode tag data to the Inspection server computer.

If the Inspection server computer does not receive the arrival message from the mobile computing device after a certain time, the Inspection server computer performs an escalation workflow. The escalation workflow comprises a step of the Inspection server computer sending a reminder message to the mobile computing device. If the Inspection server computer still does not receive the arrival message from that mobile computing device after a certain time, the Inspection server computer later sends an alert message to the next higher authority to escalate this matter to the next higher authority.

If the Inspection server computer detects from the arrival message that the maintenance person is at a wrong location, the Inspection server computer sends a location warning message to the mobile computing device for alerting the maintenance person.

The maintenance person can later input text messages on the mobile computing device to elaborate on the fault detected and to explain what has been done to rectify it. The maintenance person can take pictures of the fault before and after the rectification and then sends the pictures to the Inspection server computer. Upon completion of the work, the maintenance person uses the mobile computing device for sending a message to the Inspection server computer to indicate time of completion of work.

The alert service can comprise the mobile computing device reading in a location information data at the client terminal computer that has issued the user feedback message, which indicates a user alert. The mobile computing device later issues a site data message containing the location information data to the Inspection server computer. After this, the Inspection server computer receives the site data message containing the location information data.

This step allows the location information data to be obtained from the client terminal computer, which already exists while without requiring additional infrastructure.

Alternatively, the alert service can also comprise a step of the client terminal computer receiving phone identity data relating to the mobile computing device that has received the alert message. The phone identity data acts as mobile computing device identity data. The client terminal computer afterward issues a data message containing the phone identity data to the Inspection server computer. Later, the Inspection server computer receives the data message containing the phone identity data.

This act enables the Inspection server computer to identify the mobile computing device from the phone identity data, which is included in to generate the site report.

The Inspection server computer often stores the received data for evaluation purposes or data-mining purposes. The Inspection server computer also often forwards the stored received data to a reporting server computer for further data-mining purposes.

The user feedback data acquisition service can comprise a step of the client terminal computer storing the pre-determined user feedback message. The Inspection server computer receives the pre-determined user feedback message from the client terminal computer when a communication link between the client terminal computer and the Inspection server computer is established.

When the communication link between the client terminal computer and the Inspection server computer is disrupted, the client terminal sores the user feedback message and sends the user feedback message to the Inspection server computer when the communication link is resolved.

The application provides a method for operating a client terminal computer of a facility management service. The method comprises a step of the client terminal computer providing a user feedback data acquisition service and a wait service.

Referring to the wait service, it comprises the client terminal computer waiting for a trigger signal at a trigger port of the client terminal computer. Upon reception of the trigger signal, the client terminal computer changes to provide the user feedback data acquisition service.

Referring to the user feedback data acquisition service, it comprises the client terminal computer providing a predetermined set of user feedback messages on a display device. The feedback messages relate to service comments that are provided for a user to select.

Later, a user input relating to the feedback message is provided to a tactile input device of the client terminal computer. The client terminal computer then issues out a predetermined user feedback message over a client wireless communication module to an Inspection server computer. The predetermined user feedback message is selected or is generated according to the received user input. The client terminal computer afterward changes to provide the wait service.

This step allows collection of service feedback to be done immediately after the service is provided. In an event of service failure, the fast service feedback allows a quick response to the service failure.

Other means of generating the trigger signal are possible. In one implementation, a scanning of a purchase item generates the trigger signal. In another implementation, a printing of a sale receipt generates the trigger signal.

After lapsing a pre-determined wait time without receiving a user input into the tactile input device, the user feedback data acquisition service can comprise a step of the client terminal computer changing to provide the wait service.

The user feedback data acquisition service closes or ceases after the lapse of the wait time when no user input is received. The client terminal computer deems that the user does not wish to provide any service feedback when no user input is received within the wait time. Leaving the user feedback data acquisition service active after the wait time may allow other users, rather than the actual user, from providing service feedback.

Upon receiving a first user input into the tactile input device, the user feedback data acquisition service can also comprise a step of the client terminal computer providing a predetermined second set of user feedback messages on the display device. The second set of user feedback messages can be generated or be selected according the first user input. Upon receiving a second user input into the tactile input device, the client terminal computer changes to provide the wait service.

This step provides a two level service feedback, which is able to provide a detailed service feedback. Although a two level feedback is described here, three or more levels of service feedback are also possible.

The application provides a further for supporting facilities management services. The system comprises one or more client terminal computers and one or more mobile computing devices.

The system also includes a server computer wireless communication module and a server computer wireless phone module. The server computer wireless communication module is also known as an Inspection server computer wireless communication module while the server computer wireless phone module is also known as an Inspection server computer wireless phone module.

In particular, each client terminal computer includes comprising a display device, at least one corresponding tactile input device, as well as a client wireless communication module.

In use, the server computer wireless communication module is used for communicating with the client terminal computer and for communicating with an Inspection server computer. In other words, the server computer wireless communication module transfers data between the client terminal computer and the Inspection server computer.

Similarly, the server computer wireless phone module is intended for communicating with the mobile computing device and for communicating with the Inspection server computer.

The system provides a user feedback data acquisition mode, an alert mode, and a site inspection mode.

In the user feedback data acquisition mode, the client terminal computer provides a pre-determined set of user feedback messages on the display device for receiving feedback about a facility or service from users. Upon receiving a user input about the facility into the tactile input device, the client terminal computer issues a pre-determined user feedback message over the client wireless communication module. The Inspection server computer wireless communication module then receives the pre-determined user feedback message from the client terminal computer. The Inspection server computer wireless communication module later sends the pre-determined user feedback message to the Inspection server computer.

In the alert mode, the server computer wireless phone module receives the alert message from the Inspection server computer and it then the alert message. The alert message is intended for instructing a supervisor to proceed to the said client terminal computer that has issued the respective user feedback message that indicates a user alert. Put differently, the user feedback message about the facility triggers the Inspection server computer to send an alert message to the mobile computing device of the supervisor via the server computer wireless phone module.

In the inspection mode, the Inspection server computer receives an inspection data list from the Inspection server computer, wherein the server computer wireless phone module issues the inspection data list to a mobile computing device of a maintenance staff. Upon the maintenance staff arriving at a location indicated in the inspection data list, the maintenance staff uses the mobile computing device to read in predetermined location information data that corresponds to the inspection data list. The reading of the pre-determined location information data can be used to indicate that the maintenance staff is present at the indicated location.

The mobile computing device then receives site inspection data from the maintenance staff. The mobile computing device later issues a site data message containing the location information data and the site inspection data to the server computer wireless phone module. The computer wireless phone module afterwards receives the site data message containing the location information data and the site inspection data and send the said site data message to the Inspection server computer.

The alert mode can include a step of the mobile computing device reading in a location information data at the client terminal computer that has issued the respective user feedback message that indicates a user alert. The mobile computing device afterward issues a site data message containing the location information data. After this, the server computer wireless phone module receives the site data message containing the location information data for sending the said site data message to the Inspection server computer.

The alert mode can also include a step of the client terminal computer receiving phone identity data relating to the mobile computing device that has received the alert message. The client terminal computer later issues a data message containing the phone identity data. The server computer wireless communication module later receives the data message containing the phone identity data for transmitting the said data message to the Inspection server computer. This step has a benefit of providing authentication of data source.

The mobile computing device can provide audio or voice communication capabilities with other mobile computing devices.

The mobile computing device can also comprise a text data input device for receiving a text message.

The mobile computing device and the Inspection server computer wireless phone module each comprises a WLAN communication module or a GSM communication module, although other communication modules are also possible.

The alert message is often sent in an SMS format.

The client wireless communication module and the Inspection server computer wireless communication module can each comprise a WLAN communication module or a GSM communication module.

Messages between the Inspection server computer wireless communication module and the client terminal computer can be transmitted in an SMS format.

The inspection data list can comprise blank data fields for receiving the site inspection data, wherein the site data message comprises the inspection data list and the site inspection data.

The mobile computing device can also comprise a camera being configured as a Bar code reader.

The client terminal computer can further comprise a client memory unit for storing client data, wherein the client data is provided for transmitting to the Inspection server computer wireless communication module.

The application provides a method for operating a management service. The method comprises the management service providing a user feedback data acquisition service, an alert service, and a site inspection service.

In particular, the user feedback data acquisition service comprises a step of a client terminal computer providing a predetermined set of user feedback messages for receiving feedback about a facility or service from users. Upon receiving a user input about the facility or service, the client terminal computer then issues a pre-determined user feedback message. A server computer wireless communication module then receives the pre-determined user feedback message from the client terminal computer for transmitting the pre-determined user feedback message to an Inspection server computer.

The alert service comprises a step of a server computer wireless phone module receives an alert message from the Inspection server computer. The server computer wireless phone module then issues the alert message to a mobile computing device for instructing a staff, who may work in the area of maintenance or cleaning, to proceed to the client terminal computer that has issued the user feedback message that indicates the user alert.

The inspection service comprises a step of the server computer wireless phone module receiving an inspection data list from the Inspection server computer and then issuing the inspection data list to the mobile computing device for instructing the staff regarding inspection of the facility. The mobile computing device later reads in pre-determined location information data that corresponds to the inspection data list. This is for indicating the staff is present at the said facility.

The mobile computing device later receives site inspection data about the facility from the staff. The mobile computing device afterward issues a site data message containing the location information data and the site inspection data to the server computer wireless phone module.

The server computer wireless phone module later receives the site data message containing the location information data and the site inspection data from the mobile computing device and then transmits the said site data message to the Inspection server computer.

The alert service may include a step of the mobile computing device reading in a location information data at the client terminal computer that has issued the user feedback message that indicates a user alert. The mobile computing device later issues a site data message containing the location information data. After this, the server computer wireless phone module receives the site data message containing the location information data and then sends the said site data message to the Inspection server computer.

The alert service can also include a step of the client terminal computer receiving phone identity data relating to the mobile computing device that has received the alert message. The client terminal computer then issues a data message containing the phone identity data, wherein the server computer wireless communication module later receives the data message containing the phone identity data and later transmits to the said data message to the Inspection server computer.

The user feedback data acquisition service can include a step of the client terminal computer storing the pre-determined user feedback message. The server computer wireless communication module then receives the pre-determined user feedback message from the client terminal computer and transmits the pre-determined user feedback message to the Inspection server computer when a communication link between the client terminal computer and the Inspection server computer wireless communication module is established.

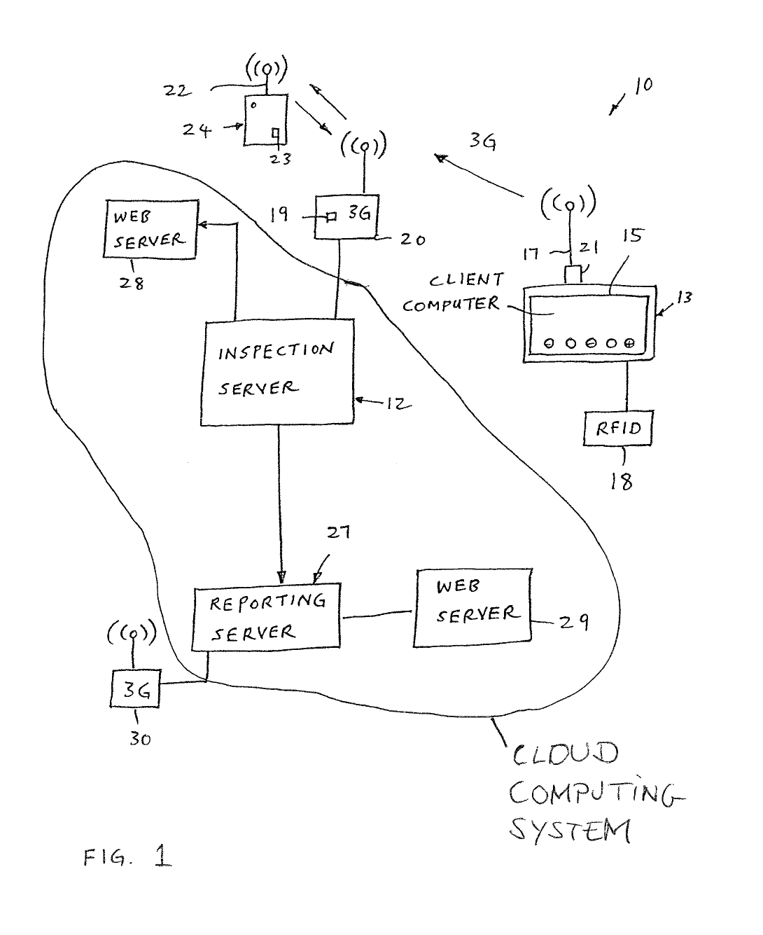

FIG. 1 illustrates an embodiment of an integrated feedback management system,

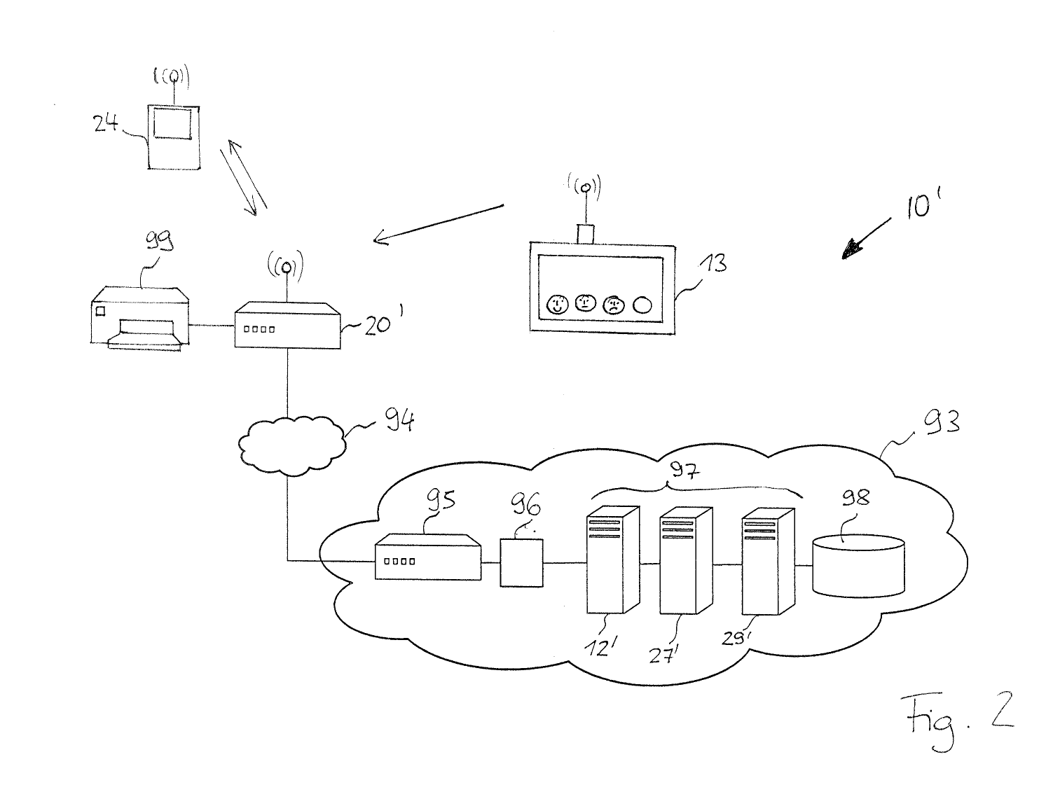

FIG. 2 illustrates a further embodiment of the integrated feedback management system using a cloud computing system,

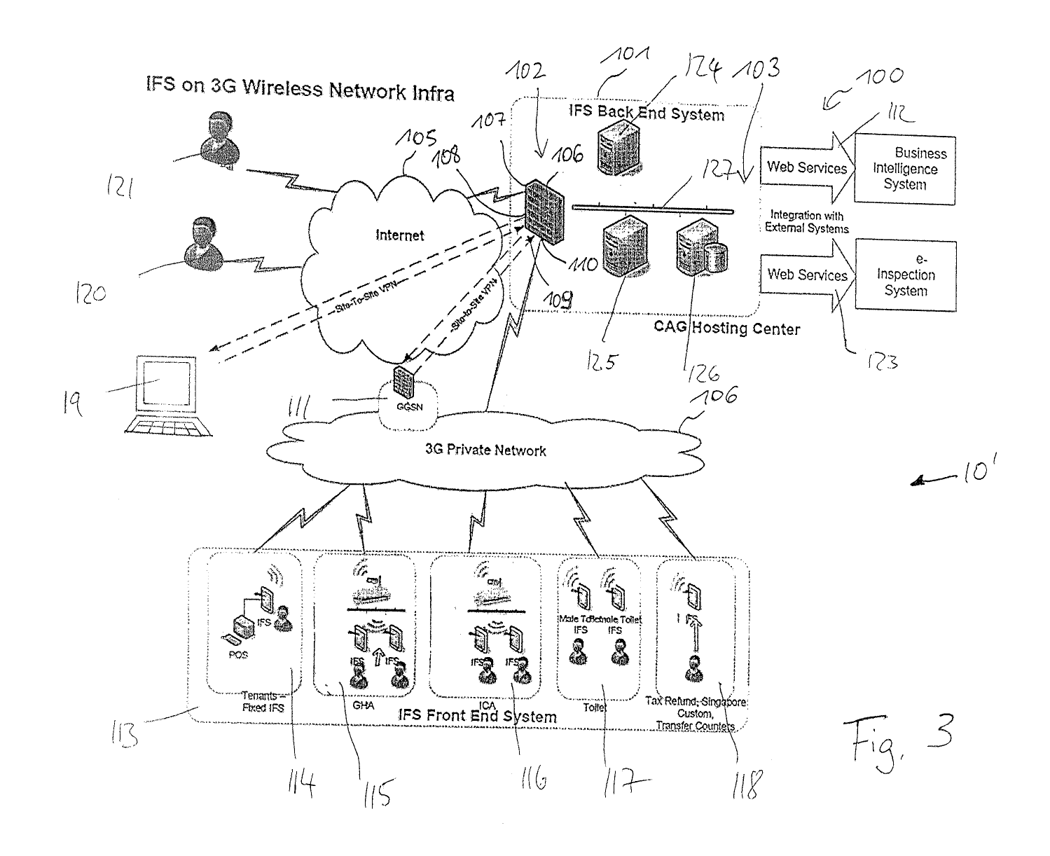

FIG. 3 illustrates a communication infrastructure of the feedback management system of FIG. 2,

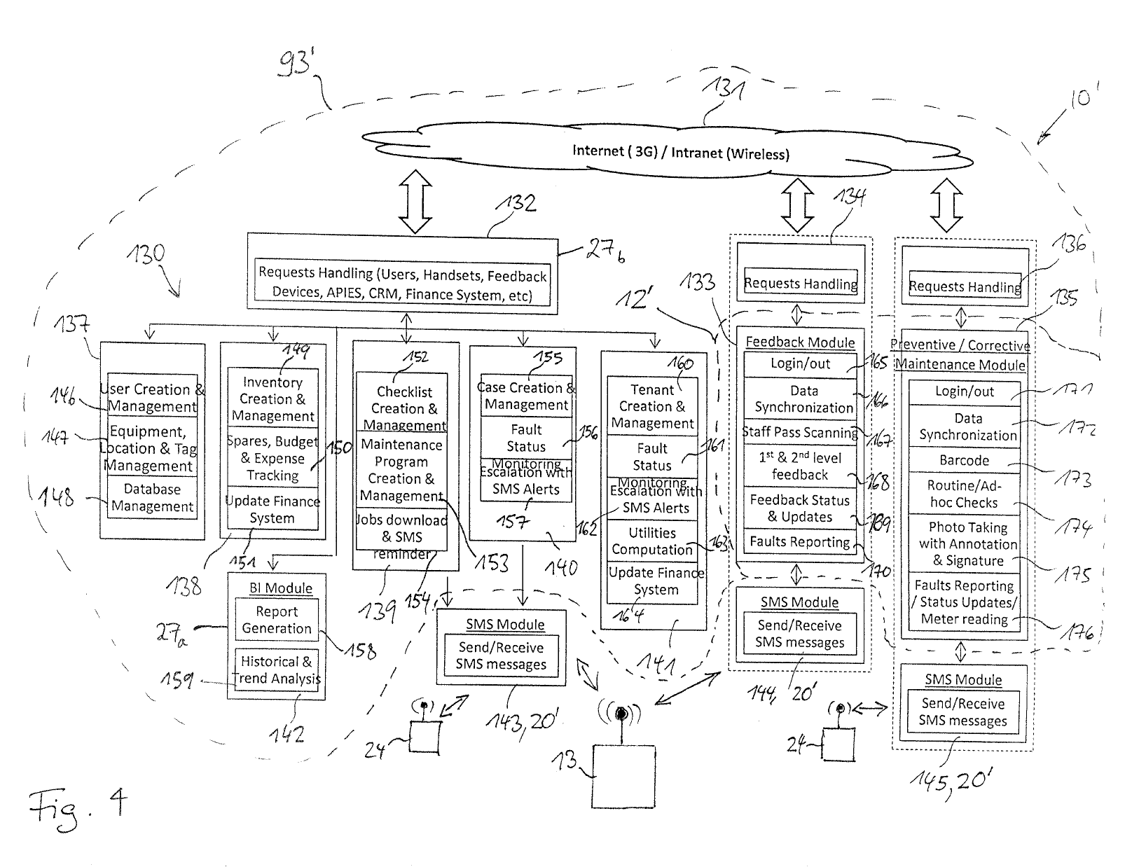

FIG. 4 illustrates various modules of the feedback management system of FIG. 2,

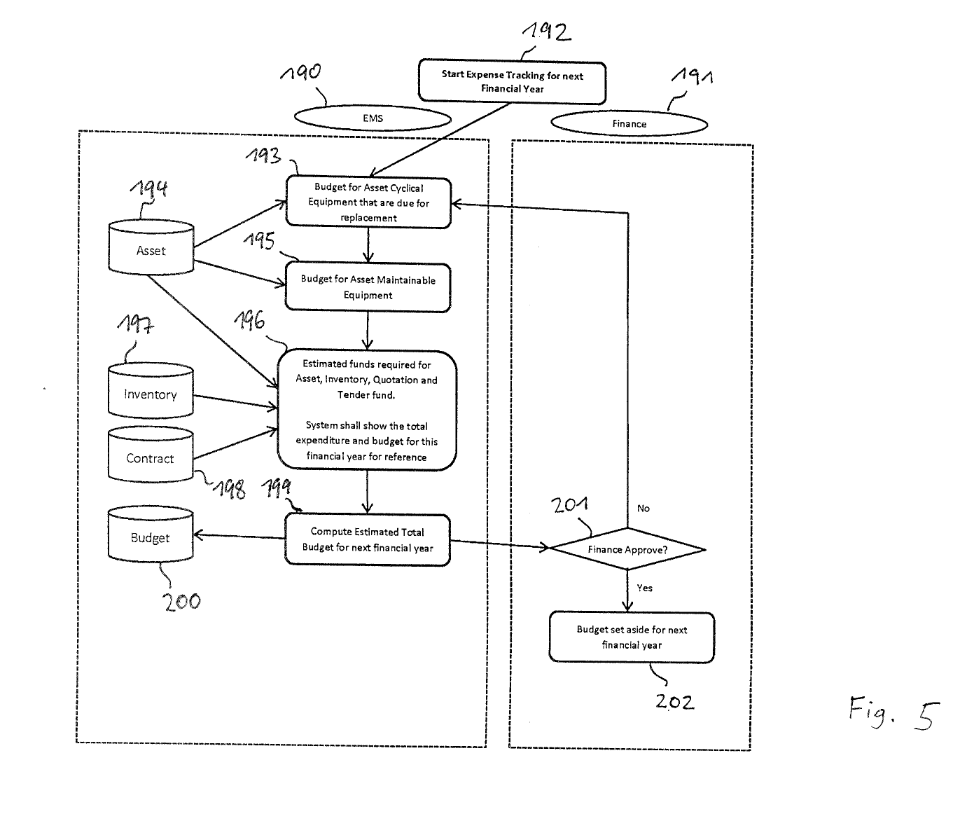

FIG. 5 illustrates an expense tracking process of the modules of FIG. 4 for a financial year,

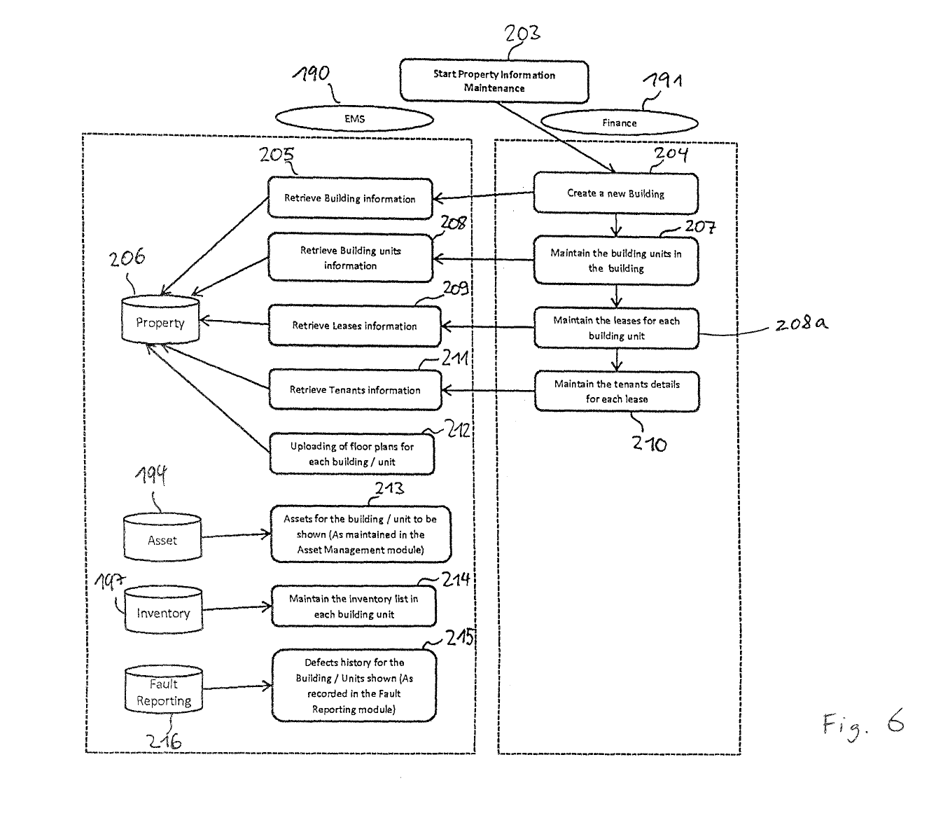

FIG. 6 illustrates a property information maintenance process of the modules of FIG. 4,

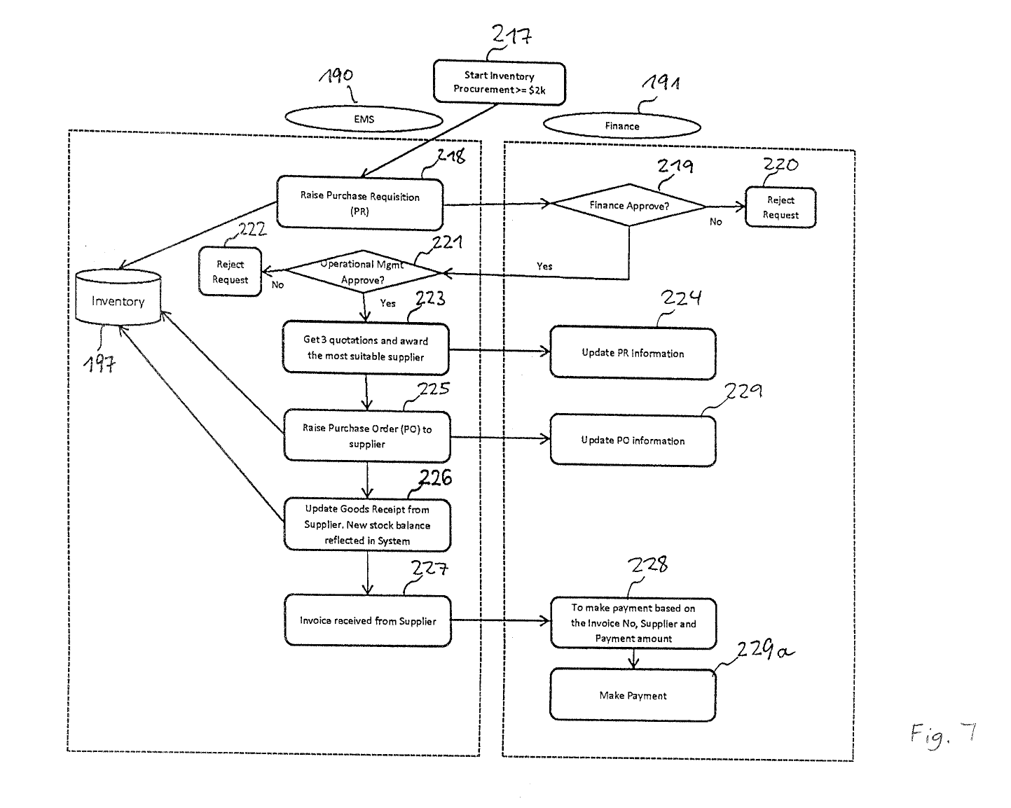

FIG. 7 illustrates an inventory purchase process of the modules of FIG. 4 for a high value inventory,

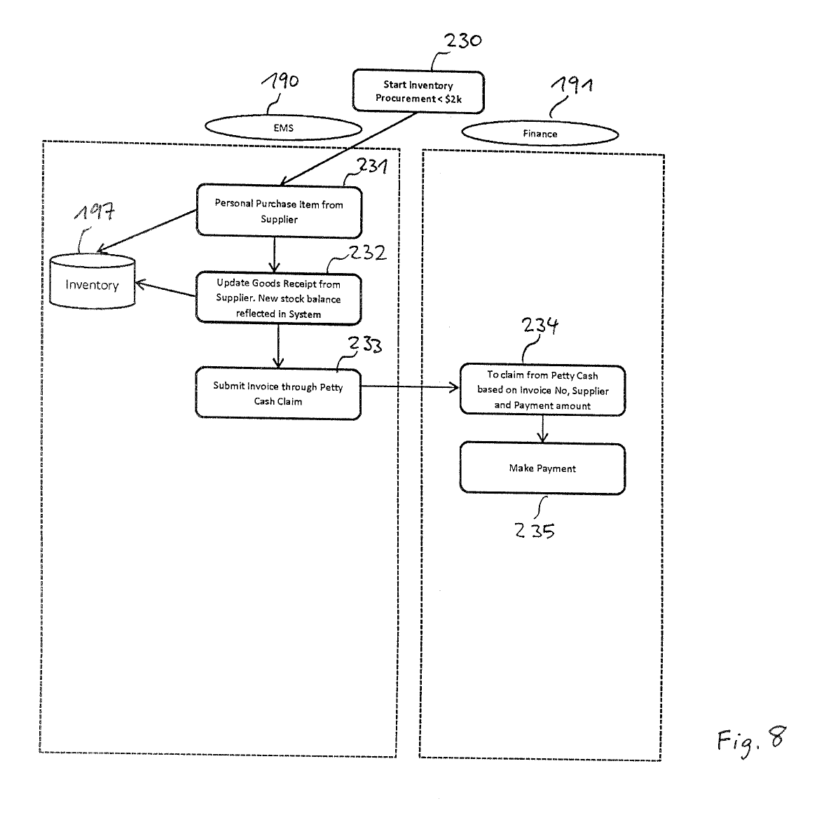

FIG. 8 illustrates an inventory purchase process of the modules of FIG. 4 for a low value inventory,

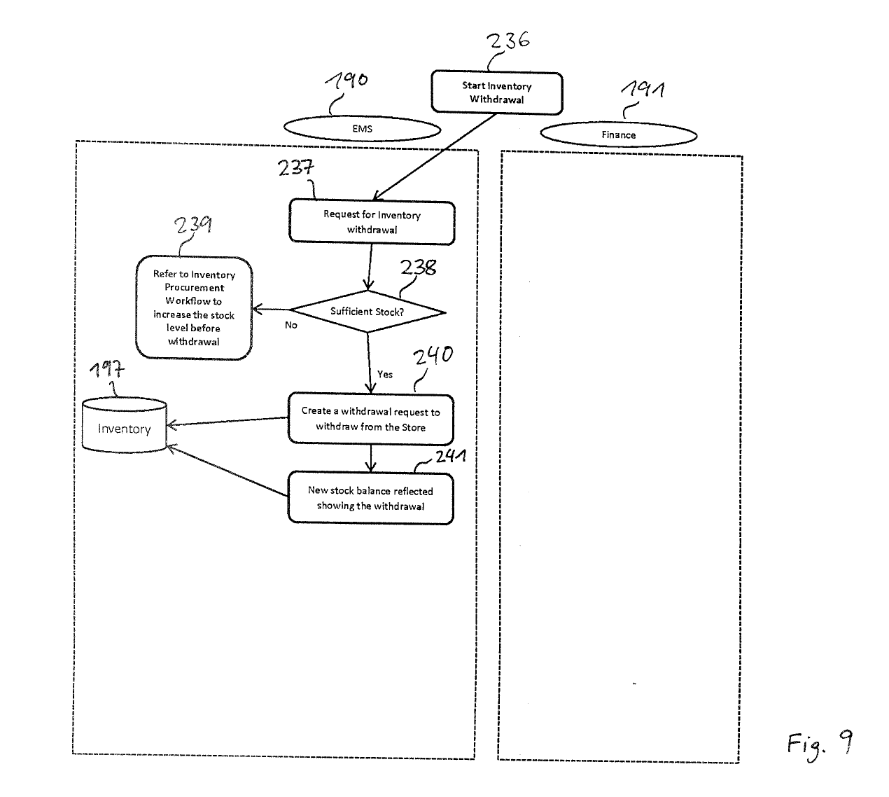

FIG. 9 illustrates an inventory withdrawal process of the modules of FIG. 4,

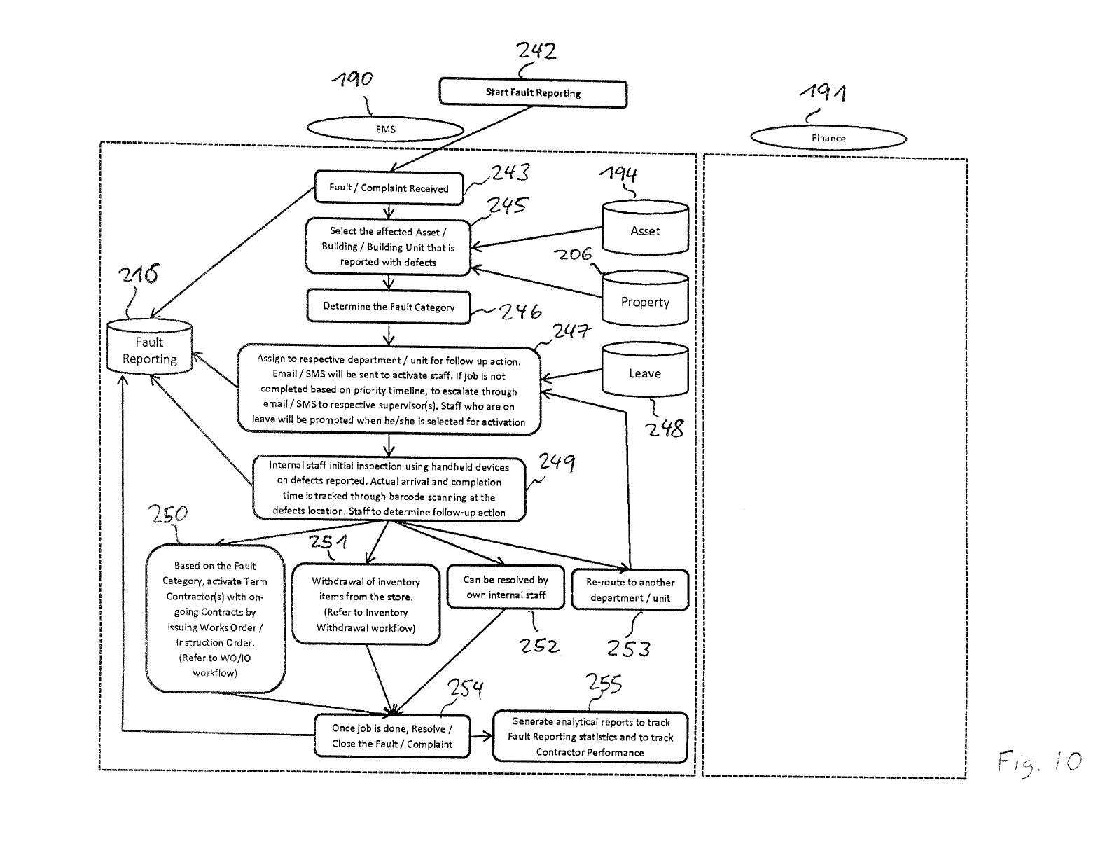

FIG. 10 illustrates a fault reporting process of the modules of FIG. 4,

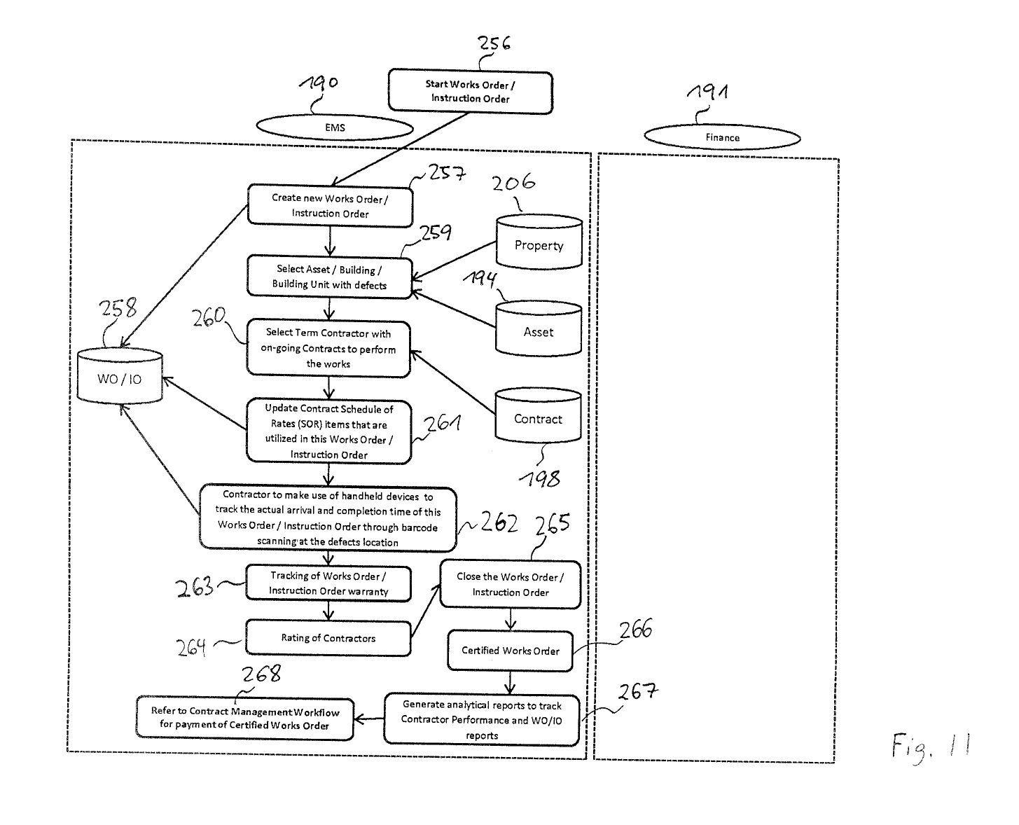

FIG. 11 illustrates a work order creation process of the modules of FIG. 4,

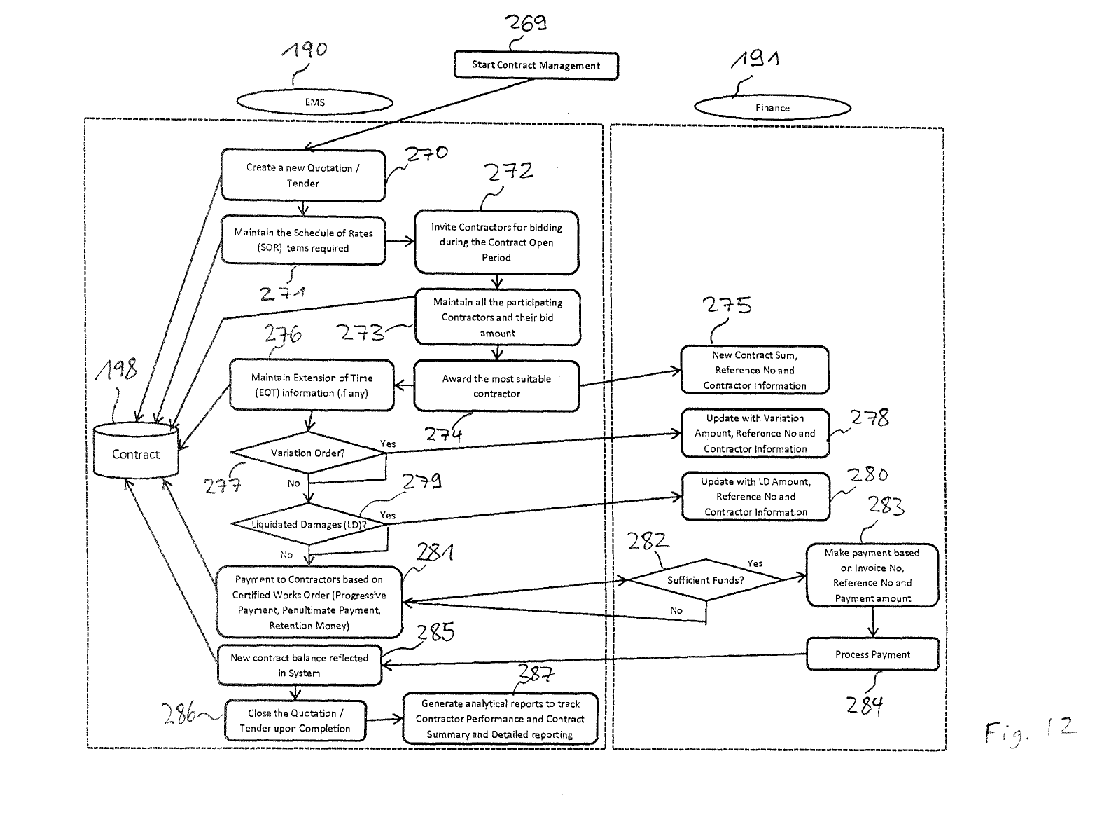

FIG. 12 illustrates a contractor selection and payment process of the modules of FIG. 4,

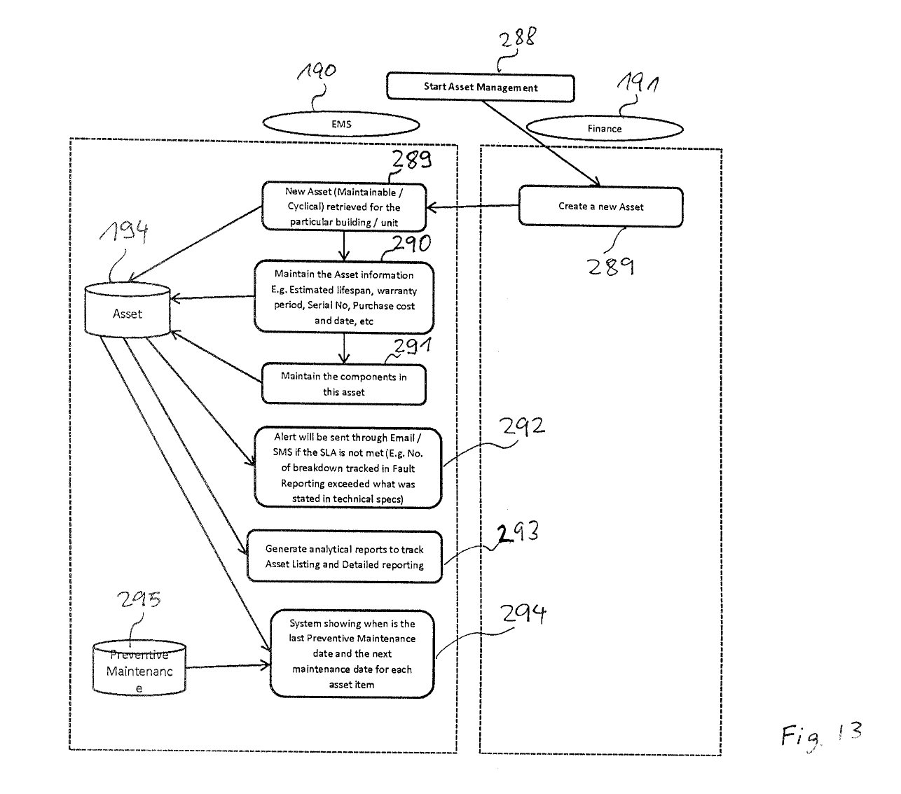

FIG. 13 illustrates an asset management process of the modules of FIG. 4,

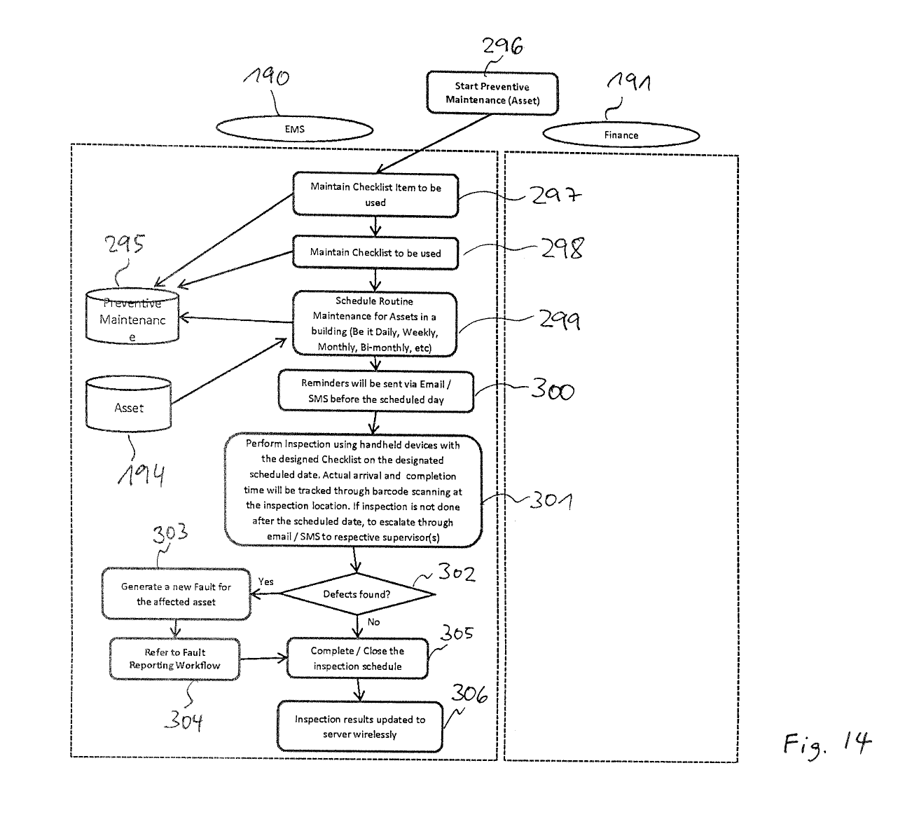

FIG. 14 illustrates a preventive maintenance process of the modules of FIG. 4 for an asset,

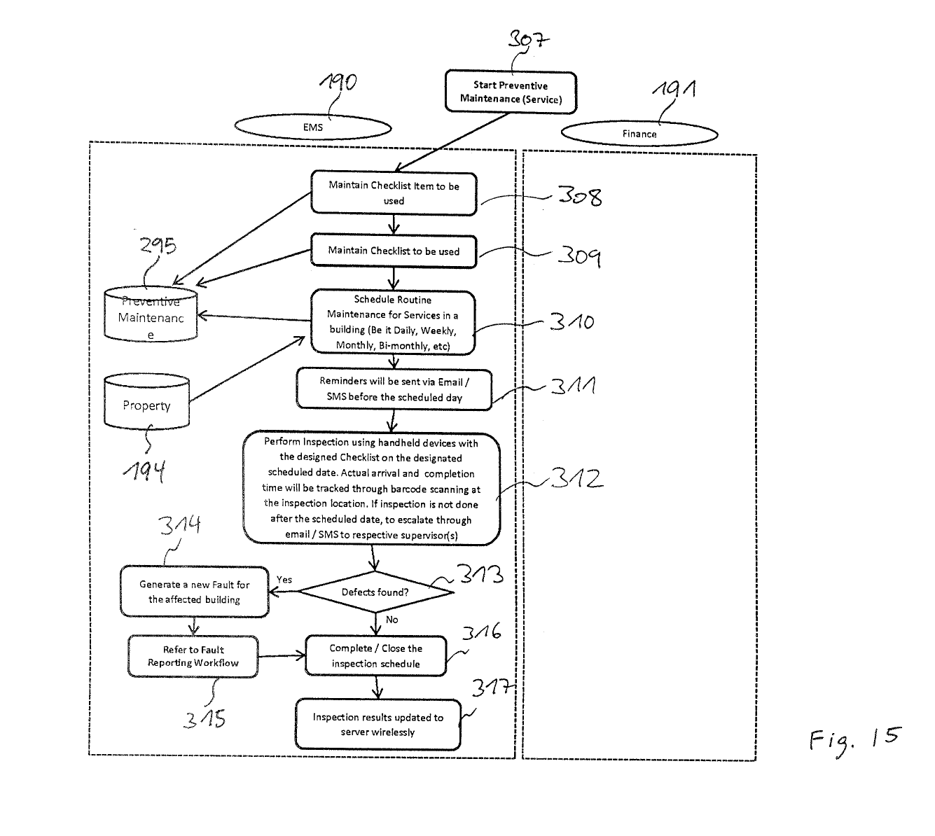

FIG. 15 illustrates a preventive maintenance process of the modules of FIG. 4 for a service,

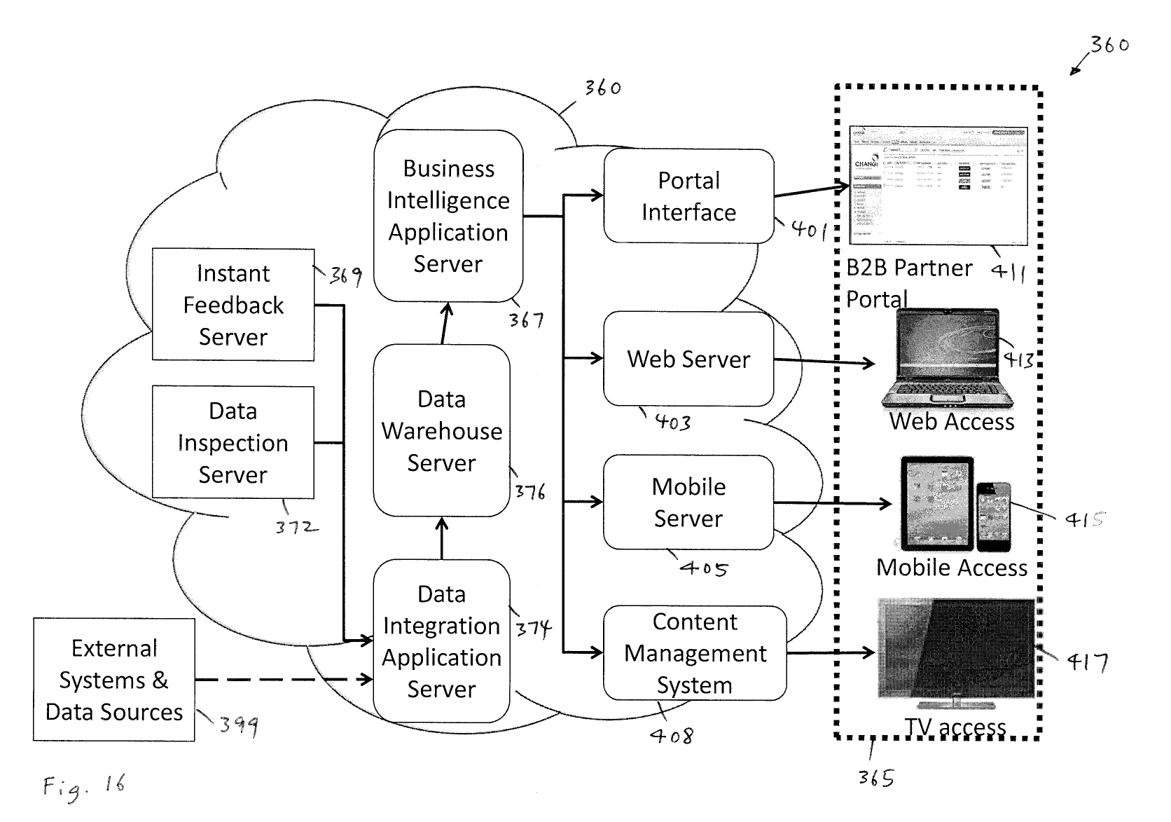

FIG. 16 illustrates a hardware block diagram of the integrated feedback management system of FIG. 2,

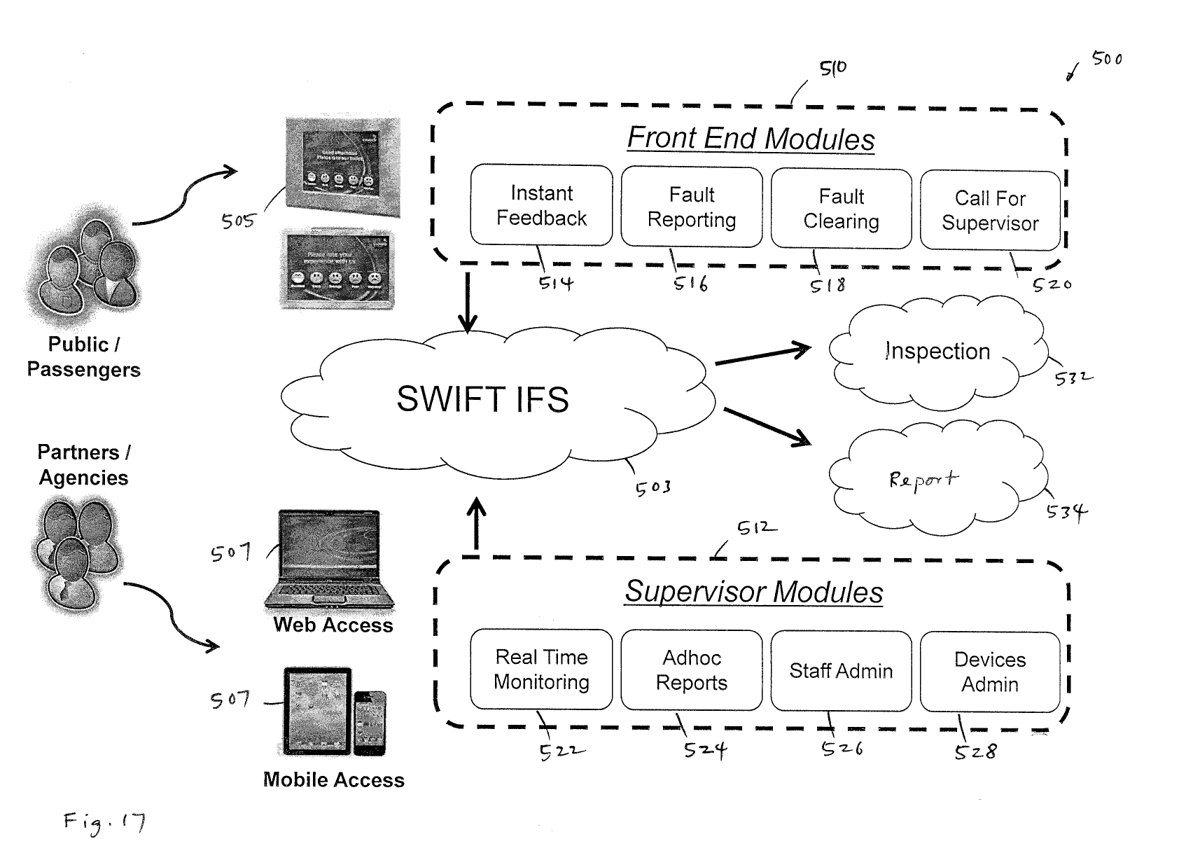

FIG. 17 illustrates a software block diagram of the integrated feedback management system of FIG. 2, and

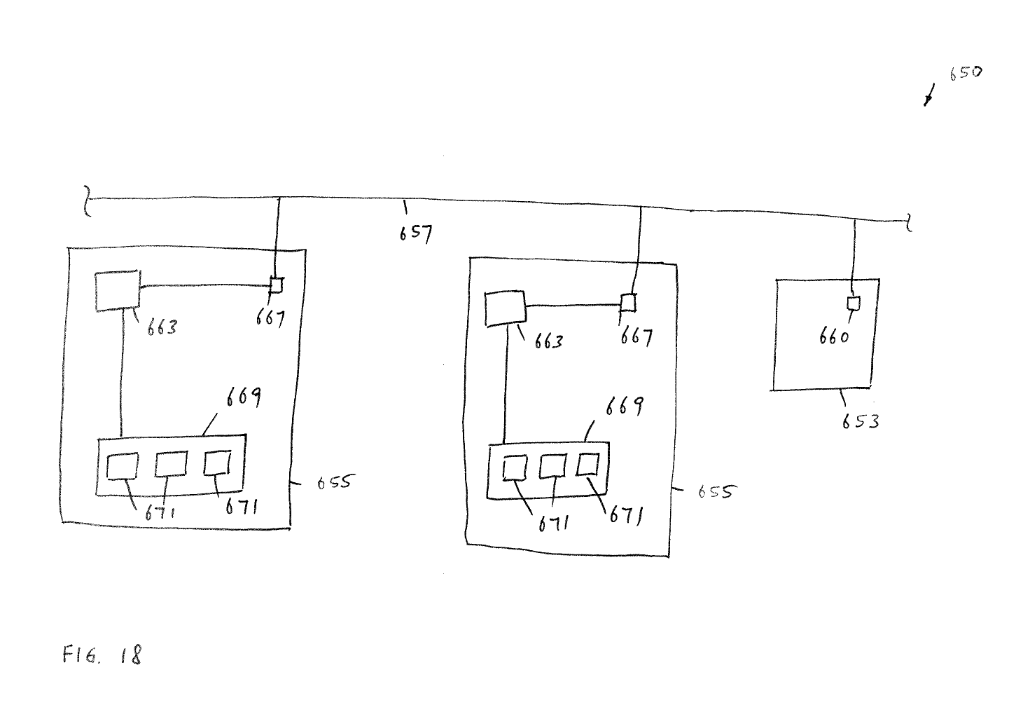

FIG. 18 illustrates an embodiment of the cloud computing system of FIG. 2.

In the following description, details are provided to describe embodiments of the application. It shall be apparent to one skilled in the art, however, that the embodiments may be practiced without such details.

Some parts of the embodiments, which are shown in the Figs. below, have similar parts. The similar parts may have the same part numbers or similar part numbers with a prime symbol. The description of such similar parts also applies by reference to other similar parts, where appropriate, thereby reducing repetition of text without limiting the disclosure.

In the description below, the term customers refers to external customers, such as passengers and airport users, although the term can also refer to internal customers. Services provided by one department of a business entity to another department of the same business entity can be viewed as services provided by one department to its internal customer.

The passengers and airport users can receive services from frontline staff of an airport terminal and also receive services from facilities, such as a toilet, of the airport terminal. The term airport and the term airport terminal are used interchangeably. The airport terminal facilitates boarding of passengers onto an aircraft as well as disembarking of passengers from the aircraft.

For sake of shortness, the embodiments of WO 2012/042422 with its alternatives and implementations are included here as a reference. The embodiments are shown at:
page 4, line 1 to page 16, line 32 together with FIGS. 1 to 7 of WO 2012/042422 with its alternatives and implementations relates to an embodiment of an integrated feedback management system,
page 17, line 1 to page 23, line 3 together with FIGS. 8 to 10 of WO 2012/042422 with its alternatives and implementations relating to another embodiment of an integrated feedback management system,
page 23, line 5 to page 24, line 4 together with FIG. 11 of WO 2012/042422 with its alternatives and implementations relating to a further embodiment of an integrated feedback management system, and
page 24, line 6 to page 25, line 24 together with FIG. 12 of WO 2012/042422 with its alternatives and implementations relating to another embodiment of an integrated feedback management system.

FIG. 1 shows one embodiment of an integrated feedback management system 10.

The feedback management system 10 includes an inspection server 12 and a plurality of front-end client computers 13. The inspection server 12 is connected communicatively to the client computers 13. The term server refers to a main computer that is used to control other computers or to communicate with other computers and for storing data, which has been provided by other computers. A server can also evaluate and manipulate this data.

The client computer 13 includes a touch screen 15. The touch screen 15 is also known as a touch point terminal. The touch screen 15 is electrically connected to an antenna 17 via a wireless GSM (Global System for Mobile Communications) communication module 21 and to an RFID (radio frequency identifier) card reader 18.

The inspection server 12 has a wireless 3G (Third Generation) modem 20 that is communicatively connected to the client computer antenna 17 and to an antenna 22 of a smart phone 24 using SMS (Short Message Service) technology. The smart phone 24 refers to a mobile phone with a certain computing ability. The smart phone 24 has a built-in camera 25. The inspection server 12 is also connected to other web servers or computers 28 via the Internet and to a reporting server 27. The computer 28 comprises a web server that acts as a software application.

The 3G modem 20 and the smart phone 24 each have one wireless GSM communication module 19 and 23, respectively, for communicating with each other. The computer antenna 17 is also connected to the wireless GSM communication module 21 of the client computer 13.

The reporting server 27 is connected to other web servers or computers 29 via the Internet. The reporting server 27 also has a wireless 3G modem 30. The computer 29 comprises a web server that acts as a software application.

In a general sense, for communicating with each other, the inspection server 12 and the smart phone 24 can have wire-less network communication modules, WLAN (Wireless Local Area Network) communication modules, or other wireless communication modules, instead of the GSM communication modules. The WLAN communication modules use Wi-Fi communication protocol as published by the Wi-Fi Alliance.

Similarly, the client computer 13 and the inspection server 12 can also have GSM communication modules, WLAN communication modules, or other wireless communication modules for communicating with each other. While the RFID card reader 18 is one form of a card reader, other forms of the card reader are also possible.

The server 28, the inspection server 12, the reporting server 27, the servers 29 are provided by a cloud computing system.

The cloud computing system comprises several computer servers, wherein the computer servers provide services, such as retrieval of data from a data storage device and manipulation of data. These computer servers have a centralized supervision that provides load balancing. In other words, the supervision allocates tasks to the computer servers such that the computers servers are essentially balanced or evenly loaded. The computers servers are also scalable in which their computing capabilities can be changed.

FIG. 2 shows a further embodiment of the integrated feedback management system. FIG. 2 depicts an integrated feedback management system 10′ using a cloud computing system 93.

The cloud computing system 93 is connected to a modem and router 20′ via a network 94, such as the internet. The modem and router 20′ comprises an antenna and a communication module for connecting wirelessly to the smart phone 24 and to the front-end client computer 13. In particular, the communication module can be provided by a module for a 3G protocol.

The cloud computing system 93 comprises a router 95 which is connected to a load balancer 96. The load balancer 96 is connected to computing resources 97 and to data storage 98. All or part of the data storage is administered by a database management system (DBMS).

The computing resources 97 comprise a virtual inspection server 12′, a virtual reporting server 27′ and a virtual web server 29′. The load balancer 96 comprises applications for balancing the load between available servers. The applications of the load balancer 96 may provide DNS based server load balancing capabilities, NAT based server load balancing capabilities or flat-based server load balancing capabilities, for example.

An output device 99 for outputting reports, such as a printer, is connected to the modem 20′.

During operation, the load balancer 96 dynamically allocates the computing resources 97 to the virtual inspection server 12′, the virtual reporting server 27′ and the virtual web server 29′. Depending on the required computing performance and the performance of the underlying hardware, the cloud computing system 93 can be configured using the load balancer 96 to execute each of the virtual servers 12′, 27′, 29′ on several computers or also to execute several virtual servers 12′, 27′, 29′ on the same computer. The cloud computing system 93 can also be configured to provide a combination of these configurations, in which for example the virtual servers 12′, 27′ are distributed over a first set of computers and the virtual server 29′ is distributed over a second set of computers.

The computers, which provide the virtual servers 12′, 27′, 29′ may be located in the same building or also in different buildings. In a further embodiment, the computers may also be geographically distributed or even distributed across countries. A cloud computing system 93 with geographically distributed resources is also referred to as “distributed cloud computing system”. In a distributed cloud computing system 93, the computers communicate via modems and provide a means of secure communication, for example by using an encrypted data transfer.

In addition to the load balancer 96, the cloud computing system 93 comprises a hypervisor application, which provides a virtualization interface. The virtualization interface of the hypervisor application provides an abstraction from the underlying hardware, which provides the computing resources, the networks and the data storage.

According to a further embodiment, the cloud computing system 93 is configured to comprise predetermined scalability rules. The scalability rules specify how and when applications using the virtual servers 12′, 27′, 29′ can grow and consume more resources from the cloud. The scalability rules may depend on thresholds of observed metrics such as data traffic, data amount, statistics of CPU load etc.

A resource selection may be done using optimization algorithms, such as simple heuristics with thresholds, linear programming, Lyapunov optimization or others. Moreover, artificial intelligence algorithms, biologically inspired algorithms and game theory may also be applied.

FIG. 3 shows a communication infrastructure 100 of a feedback management system of FIG. 2. A back end system 101 comprises a first communication gateway 102 and a second communication gateway 103. The first communication gateway, which is connectable to communication networks such as the internet 104 or a 3G private network 105, is connected to a firewall 106. The first communication gateway 102 comprises first, second, third and fourth interfaces 107, 108, 109, 110. The first interface 107 is provided for browser based and text based applications and the second interface 108 is provided for site-to-site virtual private network (VPN) connections. The first interface 107 and the second interface 108 are configured for communication via the internet 105. The first and second interfaces 107, 108 may also provide communication via other similar networks, especially TCP/IP based or IP based intranets and extranets.

The third interface 109 is provided for site-to-site VPN connections via a 3G private network and the fourth interface 110 is provided for other connections via the 3G private network. The third and fourth interfaces 109, 110 may support other radio access networks as well, which may be circuit switched or packet switched. The third interface 109 is connectable to a gateway GPRS support node (GGSN) 111 of the 3G private network via a second firewall 112. According to this embodiment, the fourth interface 110 can be used for a 3G back up or as a redundant link, for example.

A front-end system 113 is connectable to the 3G private network 106. The front-end system 113 comprises, among others, a tenant interface 114, a global hotel alliance (GHA) interface 115, an immigration and checkpoint authority (ICA) interface 116, a janitorial inspection interface 117 and a customs office interface 118.

By way of example, FIG. 3 shows a monitoring system 119, which is connected via the second interface 108, a supervisor 120, which is connected over the first interface 107 via a browser application and an administrator 121, which is connected over the first interface 107 via a staff registration client application. The staff registration client application provides an enhanced level of security compared to the browser application and a customized user interface.

The second gateway 103 of the back end system 101 comprises a first interface 122 for communication with an airport business intelligence system and a second interface 123 for communication with an airport electronic inspection system.

The back end system comprises a first server 124 with a centralized web based supervisor module, a second server 125 with a centralized web based staff profile registration module and a data synchronization server 126, which are linked via a network 127, such as Ethernet.

In use, the integrated feedback management system 10′ is used to obtain immediate service feedbacks from customers, e.g. in an airport. The immediate feedback refers to a feedback from a user wherein the service feedback is provided soon or quickly after the user has received the service. The service feedback is then used to transform or to improve services provided by a workforce of the airport.

Referring to the client computer 13, this device serves as an immediate or instant feedback device.

The feedback device can be installed at check-in counters, at immigration and information counters, at retail counters, as well as at food and beverage outlets. The feedback device can also be installed at other areas, including custom inspection and refund counters, and transfer counters. Being installed at these areas, the feedback device is easily accessed by passengers at these areas to register their satisfaction levels immediately after receiving their service from frontline staffs at these areas.

The touch screen is used for displaying service satisfaction ratings to customers after the customers have received services. The customers can indicate their satisfaction service ratings using multiple tactile sensors of the touch screen. A tactile sensor is sensitive to a pre-determined selective motion of a user such as a touch, a force, or a pressure.

The client computer antenna is used by the wireless communication module of the client computer 13 to transmit the received satisfaction service ratings to the inspection server 12′. The ratings are transmitted in an online and electronic manner to achieve a rapid feedback.

The service staffs use a card reader for clearing or for resetting the recorded service ratings that the client computer 13 has received and has recorded. This clearing is usually done after the service staffs have responded to anomaly in the service ratings.

Referring to the inspection server 12′, the 3G modem 20′ has a wireless communication module that is used for receiving the satisfaction service ratings transmitted by the client computer 13. The 3G modem 20′ is also used for transmitting the said ratings to a memory unit of the inspection server 12′ for storing. The memory unit is not shown in FIG. 1.

The inspection server 12′ is used to identify any unsatisfactory service rating in an automated manner and to send an alert or maintenance request regarding the unsatisfactory service rating to the smart phone 24 via the 3G modem 20′ in an automated and electronic manner. The alert is transmitted using SMS technology to push the alert to the smart phone 24.

The smart phone 24 is intended to be carried by a supervisor of the service staffs who are responsible for the areas covered by the client computers 13. After receiving the alert, the supervisor may respond to the alert. The response can include investigating the alert and initiating actions to correct the alert.

The supervisor may not respond right away in certain situations. When the alert is regarding certain shops, like restaurants, the supervisor may need to respond only after several alerts are received such that the several alerts form a consistent trend verifying that the alerts are valid. On the other hand, in the case of washroom facilities, the supervisor should respond to the washroom alert as soon as possible and not wait for several alerts confirming the validity of the alerts.

The supervisor may also generate an alert report using the smart phone 24. The report can include photographs that are taken using the smart phone camera 24. The smart phone 24 is also used to transmit the alert response report to the inspection server 12′, where they are stored for evaluation purposes.

The smart phone 24 with its built-in camera is intended for use by the supervisor to scan a 2D (two dimensional) barcode. The 2D barcode has vertical and horizontal components that are used to hold location information. Although the embodiment uses 2D barcode, other types of barcode can also be used.

In an embodiment not shown here, several smart phones are provided. Each smart phone is dedicated to a pre-determined alert message, such that an alert is pushed to the respective smart phone. There may be one smart phone for a plumber, one for a toilet paper and hand towel supplier, one for an electrician, etc.

The smart phones can be produced by different manufacturers and be provided as different models. The alert is usually sent to the smart phone held by a supervisor, who is in charge of the work shift.

The 2D barcode is location based, which means that each location has a unique 2D barcode.

The 2D barcode is fixed at certain locations and it is intended to be scanned before the supervisor starts checking or inspecting these locations. The barcode information is later used to match a data message from the smart phone with a respective data base entry for the location. The scanning of the barcode is also used to verify that the supervisor is present at the particular location and not at other locations.

The smart phone 24 is used for attaching the location information to the alert response report or to other types of report.

The smart phone 24 is also used for receiving an inspection checklist from a set of predetermined checklists that are kept at the inspection server 12′. The inspection checklist is intended for use by the supervisor to remind or to inform the supervisor about inspection tasks that the supervisor need to do at pre-determined locations.

The checklists have pre-determined content and there is a relationship between the rank or capability of the supervisor and the content of the checklist.

After using the inspection checklist to check or to inspect certain locations, the supervisor uses the smart phone 24 to generate a report regarding the checking. The report can include photographs of the location that are taken using a smart phone camera and it includes the location information obtained from the barcode.

The supervisors can also access the received service ratings that are stored in the inspection server 12′ as well as the alert response report for monitoring purpose.

The inspection server 12′ is also used for transmitting the received service ratings and the alert response report to the reporting server 27′. In one example, the service ratings and alerts are collected and are transmitted to the reporting server 27′ three times a day.

Referring to the reporting server 27′, this device is used for receiving the service ratings together with the alert response report. The reporting server 27′ is used for generating management reports using the received service ratings. The management reports can be generated every period, which can be a week or a month. The management reports can include trend charts and other analytical graphs.

In a generic sense, the feedback management system 10′ acts as a system for supporting facilities management services. The front-end client computer 13 acts as a client terminal computer. The touch screen acts as a display device with a tactile input device. The antenna being connected to a communication module acts as a client wireless communication module. The inspection server 12′ acts as an Inspection server computer. The 3G modem 20′ acts as a wireless communication module for communicating with the client terminal computer and it also acts as a server wireless phone module for communicating with the smart phone.

One method of using the integrated feedback management system 10′ to response to a service report is described below. The method comprises a step of the frontline staff providing a service to a customer.

After receiving the service, the customer is able to provide immediate feedback about the service via the touch screen that is located directly in the area where the service is provided. This allows the customer to provide immediate service feedback. The customer provides an indication of the service by selecting a service rating shown on the touch screen 15.

The service rating is then transmitted to the inspection server 12′, which monitors the received service ratings. When the inspection server 12′ detects an anomaly in the service ratings, such as a dirty waiting area, the inspection server 12′ transmits an alert about the affected service to the smart phone 24.

The supervisor carrying the smart phone 24 later receives the alert and responds to the alert. The supervisor then visits the site indicated with the alert. The supervisor later scans the location barcode that is located at the site using the smart phone 24. The scanning is to verify that the supervisor is present at the particular site. The scanning obtains location information contained in the bar code, which is then stored by the smart phone 24.

After this, the supervisor conducts an inspection of the site and rectifies any found causes related to the alert. The supervisor may assign service staff or resources to rectify the reason for the alert.

The supervisor may also generate a data report about the alert using the smart phone 24. The smart phone 24 can also be used to take pictures of the site for including in the report. The smart phone 24 also attaches the received location information to the report for verifying that the supervisor is present at the said location.

The reporting server 27′ receives the service rating data and the alert and with the associated data report. The reporting server 27′ periodically generates management reports using the said received information. The management then uses the report or a trend report generated from the data to motivate, to reward, and to counsel their service staff as appropriate.

The method has an aspect of increasing the number of feedbacks from passengers, since the touch screen is conveniently located near where the customers received the service. The increased feedbacks provide a better reflection of needs of the customers, which can be used by airport agencies or groups for improving their service. The number of passenger feedback may increase by 25 times when the integrated feedback management system 10′ is used. The service feedback is also done in a real time and electronic manner, which means that the feedback is done quickly.

Besides generating analytical service report to rectify bad services, the received service ratings can be used to reward service personnel that show a good performance.

One possible implementation is for allocating bonuses, which are received by restaurants, to service personnel with good service performance. In countries, such as Singapore, restaurant customers pay a mandatory service charge that is collected by the restaurant. The restaurant owner can later allocate these service charges using the received service ratings. Service staffs with good service performance would be allocated a large part of the service charges.

The reporting server 27′ can also correlate the service ratings to other information of the customers, such as their airline travelling class, which can be business or economy, spent characteristics, nationality, and gender. In this manner, the service requirements of certain groups of the customers can be derived.

In addition, the correlation can be used to validate service feedback. This is because certain service feedback may be biased by culture and may thus need to be interpreted differently for different customer groups. This validation of the service feedback serves to avoid misinterpreting the service feedback.

One method of using the integrated feedback management system 10′ to manage work is described below.

The method comprises a step of the inspection server 12′ generating an inspection checklist or an inspection to-do list for the supervisor of frontline service staffs.

In a generic sense, the inspection checklist serves an inspection data lists.

The inspection checklist includes items be checked or be inspected. These items reflect conditions or status of a service standard that the airport management wants to achieve. The items can be regarding conditions of a facility, like a washroom. Alternatively, the items can be regarding services provided by frontline staffs.

The inspection server 12′ then sends the inspection checklist to the smart phone 24 that is assigned to the supervisor who is responsible for the respective site. After the supervisor has received the inspection checklist via the smart phone 24, the supervisor proceeds to the location indicated by the checklist.

The supervisor then scans a barcode located at the indicated location using the camera of the smart phone 24 to obtain location information contained in the barcode. The smart phone 24 later stores this location information.

The supervisor then uses the checklist to inspect the location and to rectify any matters arising from the inspection. After the inspection, the supervisor may take photographs for reporting any visual defects using the smart phone camera. After this, the supervisor generates the inspection report using the smart phone 24. The report would include any photographs taken earlier. The smart phone 24 later sends the inspection report together with the received location information to the inspection server 12′.

The method is also useful for controlling and managing quality of work or service, especially when such work is done by outsourced vendors.

In a special implementation, the client computer 13 is installed at a washroom of an airport terminal.

The airport management of this particular terminal places great emphasis on cleanliness of the washrooms. To ensure that the washrooms are clean at practically all times, the client computers 13 are installed at the washrooms.

Passengers using the washrooms are enabled to rate the cleanliness of the washrooms via an interactive touch screen 15 using a five scale points of washroom satisfaction.

When a less satisfactory rating icon is selected, the passengers are immediately prompted to indicate reasons for the selected ratings by selecting one or more other on-screen icons. These on-screen icons reflect conditions of the washroom, which includes a wet floor condition, a no-toilet paper condition, or a dirty basin condition. More icons for further conditions can be easily provided.

Once one or more of the poor conditions icons is selected, an alert is then immediately transmitted to a smart phone 24 of a cleaning supervisor for activating necessary corrective actions.

The cleaning supervisor may then visit the unsatisfactory washroom as indicated by the alert to rectify the poor condition of the washroom. The smart phone 24 is used to scan a bar code at the washroom to indicate that the supervisor is present at the washroom. The cleaning supervisor later generates a report using the smart phone 24. The smart phone 24 also attaches the washroom location information to the report.

The supervisor may alternatively log in to the respective client computer 13 using an appropriate RFID card. The client computer 13 then displays the respective feedback of the customer. The supervisor can then clear the respective response in the client computer 13, which in turn transmits the respective data as an alert report to the inspection server 12′.

Routinely, the cleaning supervisor also receives a cleaning checklist from the inspection server 12′ on the smart phone 24.

The supervisor afterward visits a location indicated by the above checklist. The smart phone 24 is then used to scan a bar code at the indicated location to receive the location information contained in the bar code.

After this, the supervisor conducts an inspection as indicated by the cleaning checklist. The supervisor also generates a report using the smart phone 24. The smart phone 24 then attaches the received location information the report.

In use, a POS (point of sale) terminal can be used in a retail outlet, such a restaurant, for accepting payment from customers.

In one implementation, the POS terminal electrically triggers the client computer 13 upon scanning a first item of a purchase by a customer. The customer is then provided with a time period to provide service rating via the client computer 13.

The time period extends from the scanning of the first item of the purchase to the end of the service rendered to the customer. In comparison, the client computer 13 is adapted to accept the service ratings from the customers within the time period.

In a further implementation, the POS terminal electrically triggers the client computer 13 to accept service feedback after accepting the payment while the client computer 13 is used for accepting or receiving service ratings from the customers. Put differently, the customers are enabled to provide service rating via the client computer 13 immediately after receiving the service, which refers here to payment of the service.

In effect, this allows each customer to provide only one service feedback. An unhappy customer may want to exaggerate his service feedback by providing multiple service feedback. This client computer 13 together with the POS terminal prevents such multiple invalid feedbacks from occurring. The client computer 13 has thus an aspect of receiving reduced invalid customer rating.

In addition, the client computer 13 has a time window in which the customer can provide the service ratings to the client computer 13. Upon completion of the time window, it is assumed that the customer does not wish to provide the service feedback. Hence, the client computer 13 does not accept any service feedback upon completion of the time window. The time window is thus used to prevent others, who are not the relevant customers, from providing a service feedback. The time window also provides an aspect of reducing invalid service feedback.

The link between the service person and the client computer is provided by an external device. No other identifier is necessary. Put simply, this service control means is simple to implement.

The client computer 13 can use a two level manner for service feedback. A state diagram for the two level service feedback can be provided.

The state diagram includes a state of the client computer 13 waiting for completion of an event, such as bill payment. The POS terminal triggers the client computer 13 when the event is completed. The client computer 13 then moves to a state of requesting for service data from the customer.

After the customer accepts the request, the client computer 13 enters into a state of entering a first level service data by the customer. Upon receiving the data from the customer, the client computer 13 then moves into a state of prompting the customer to enter a second level service data.

The two level service data structure has an aspect of allowing the customer a structured way to provide more service information.

After this, the client computer 13 returns back to the above state of waiting for completion for an event. The client computer 37 can also move back to the state 67 after waiting for a pre-determined time with the assumption that the customer does not wish to provide more data after the pre-determined time.

A state diagram of an example of an implementation of the service feedback can be provided. In this example, a sale or counter staff is servicing a customer, who is wants to purchase one particular item or a list of items.

The state diagram includes a state of the client computer 13 waiting for a completion of a bar code scanning event of the first purchase item. The bar code scanning event denotes a time-point that is close to or that is at a completion of the purchase of the item.

The above state is followed by a state of the sale staff scanning a bar code of the first item, which the customer wishes to purchase. The scanning is done using a bar code scanner that is part of a POS terminal.

The act of scanning triggers or initiates a state of a touch screen of the client computer 13, wherein the touch screen displays messages to prompt the customer for providing data or inputs relating to the service that the customer has just received. The touch screen is also adapted accordingly for receiving the inputs, which are in the form of touches from the customer.

This service data input occurs at an appropriate time when the customer has received the service or during the time when the customer is receiving the service from a particular counter staff. In other words, the collection of service feedback is immediate.

This is then followed by a state of closing or of deactivating the service data collection. This closing of the service data collection is initiated upon completion of the input of service data from the customer or after a pre-determined waiting time. When the service data request is closed or is deactivated, the client computer 13 does not take in any further service comments or inputs from the customer.

The waiting time provides a time for the customer to provide his service comments. If the client computer 13 within the waiting time receives no comment, the client computer 13 deems that the customer does not wish to provide the service comments and it then closes the service data collection. Leaving the service data collection activated beyond the waiting time may allow others, rather than the customer, to provide service comments. These service comments would probably not reflect the quality of service that is provided by the service provider.

In short, a predefined period or window is provided for the customer to provide his service comments. These service comments are captured in an electronic manner and can be processed immediately according to predetermined guidelines by the computer.

In summary, these features improve integrity of received service data. The received service data can then be used to direct service quality improvement in the required areas.

In a general sense, although the scanning of the bar code of the purchase denotes or signals a sale process, other steps, such as printing of a sale receipt, can also be used to signal the sale process and be used to trigger the request service data.

Other means to trigger the client computer 13 for requesting service feedback are possible. These means includes a button, which provides a service feedback request signal upon completion of a certain service task, such as payment of service. The means can also include a touch screen that allows the customer to initiate a service feedback. In certain cases, the means can refer to a motion sensor in which the motion sensor detects a presence of a customer in front of the client computer 37, wherein each customer is allowed to provide one single service feedback. The motion sensor does not only provide information about a specific and selective movement of the customer but it detects also the unspecific presence of one or more persons in front of the client computer 13. A group of customers would then only be allowed to enter one single customer feedback response. This can be useful for check-in counters, where several persons create one single business transaction that is valid for the multitude of persons.

In a general sense, the front-end client computer 13 acts as a client terminal computer. The touch screen acts as a display device and with one or more corresponding tactile input device. An antenna is connected to a communication module to act as a client wireless communication module for communication with a further computer device, which can be an Inspection server or a supervisor module server. The front-end client computer 13 can include a trigger port for receiving a trigger signal from the POS terminal.

A RFID reader can be used to read an RF identifier of a service provider to authenticate the service provider. Upon authentication, the service provider is allowed to access information in a client computer 13. The client computer 13 is provided for collecting customer feedback and for forwarding the customer feedback to a supervisor module server. The supervisor module server then forwards the respective data to the inspection server 12′ or to the reporting server 27′.

An integrated feedback management system, which is a variation of the above integrated feedback management system can be provided. The feedback management system includes a supervisor module server that is communicatively connected to a client computer 13. The supervisor module server includes a server memory module while the client computer 60 includes a computer memory module.

In use, the computer memory module is used for storing data received by the client computer 13 from a user. The data includes customer service data or customer comment data. The data in the computer memory are arranged in a computer database for easy access.

These data are later transferred via communication modules over a wireless medium to the server memory module. The data in the server memory module are arranged in a server database for easy access and are intended for processing by the supervisor module server.

A user can use ODBC (Open Database Connectivity), SQL (Structured Query Language), or OLEDB (Object Linking and Embedding Database) protocols for accessing or for managing these databases.

The transfer of the data from the computer memory module to the server memory module usually occurs soon after the computer memory module receives the said data. When the communication link between the supervisor module server and the client computer 13 is broken or is disrupted, the data received by the client computer 13 is not sent to the server memory module and it continues to reside in the memory module. These data are later then sent to the server memory module, when the communication link is established or restored. In other words, data synchronization between the supervisor module server and the client computer is done when the communication link is established or restored.

This feature has the advantage of allowing the feedback management system to continue working during a short disruption of the communication link.

In a general sense, data can also be sent from the server memory module to the computer memory module via the same said mechanism.

In the embodiments of the application, the phone is provided as a smart phone that supports both audio communication with other phones and data communication for transmitting data messages. While for the above embodiments it is not necessary that the phone 24 provides audio communication capabilities, this is helpful, because such a device is more acceptable to a user than a pure data communication phone that does not provide audio communication capabilities. The phone in general can be a mobile computing device but the quality of the services provided is improved if at least the supervisors are equipped with mobile computing devices that also provide instant audio communication capabilities without the necessity to plug in an external microphone and headphones. This can be done by providing a smart phone. It is then useful if this type of device is also used for receiving data such the alert data and for compiling and transmitting data such as the inspection data reports.

In short, the embodiments provide several capabilities or features for operating an airport.

Passengers at the airport are enabled by the embodiments to provide airport management with real-time or immediate feedback of services received by the passengers using predetermined terminals, such as a touch-point or touch-screen terminal. Put differently, the passengers are able to provide a service feedback soon or immediately after the passengers have received the service. The embodiments also allow tracking and monitoring of these customer feedbacks. When service recovery actions are needed for responding to these customer feedbacks, these actions can also be initiated soon after receiving these customer feedbacks.

Ratings of the customer services that are rendered or that are provided by airport frontline staff can then be derived immediately and quickly. Current trends or status of services provided by business entities operating at the airport can also be known and be analyzed rapidly for improving these business services. Modern technologies and novel innovations are used for delivering an end-to-end or comprehensive solutions for managing the airport services. The embodiments have an aspect of ensuring high standards for services and high standards for facilities at the airport.

These embodiments are different from other airport feedback systems that receive customer feedback through various channels, such as feedback kiosks within the airport terminal, manual feedback forms, airport website, and even verbally over telephone and customer information counters. These channels have a time lapse in addressing the feedback received as much time is taken to consolidate, to disseminate, to investigate, and to reply to the customers. While these channels allow the airport staffs to identify areas where its service performance falls short, the feedback is not immediate. This also limits the opportunity for the airport staffs to turn around any unpleasant service feedback.

FIG. 4 shows various modules of the feedback management system of FIG. 2. A set of management modules 130 is connectable to a communication network 131 via a first web services module for request handling 132, also known as request handling module 132. A feedback module 133 is connectable to the communication network via a second web services module for request handling 134, also known as request handling module 134. Furthermore, a maintenance module 135 is connectable to the communication network 131 via a third web services module for request handling 136, also known as request handling module 136.

The set of management modules 130 comprises an administration module 137, an inventory module 138, a business information (BI) module 142, a planning and scheduling module 139, a faults management module 140, and a handover/takeover module 141. Furthermore, the set of management modules 130 comprises an SMS module 143 for sending and receiving SMS messages from and to the planning and scheduling module 139 and from and to the handover/takeover module 140 via a telecommunication network.

The SMS modules 143, 144, and 145 can be provided as a part of the modem 20′ or these can be an additional connection between a communication system provider and the management modules 130.

Likewise, a second SMS module 144 is provided for sending and receiving messages from and to the feedback module 133 via the telecommunication network and a third SMS module 145 is provided for sending and receiving messages from and to the maintenance module 135 via the telecommunication network.

The modules of the set of management modules 130 comprise various specialized applications. The administration module 137 comprises a user creation and management application 146, an equipment location and tag management application 147 and a database management application 148.

The inventory module 138 comprises an inventory creation and management application 149, a spares and budget and expense tracking application 150 and a finance system updating application 151.

The planning and scheduling module 139 comprises a checklist creation and management application 152, a maintenance program creation and management application 153 and a jobs download and SMS reminder application 154.

The faults management module 140 comprises a case creation and management application 155, a fault status monitoring application 156 and an alerting and escalation application 157.

The BI module 142 comprises a report generation application 158 and a history and trend analysis application 159.

The handover/takeover module 141 comprises a tenant creation and management application 160, a fault status application 161, an escalation monitoring application 162, a utilities computation application 163, and a finance system updating application 164.

Similarly, the feedback module 133 comprises a login application 165, a data synchronization application 166, a staff pass code scanning application 167, a first and second level feedback application 168, a feedback status and update application 169 and a faults reporting application 170.

Similarly, the maintenance module 135 comprises a login application 171, a data synchronization application 172, a barcode handling application 173, a service checking application 174, a photo handling application 175 as well as a fault reporting and status update application 176.

According to this embodiment, various feedback devices may be connected to the SMS modules for sending and receiving SMS messages. In particular, these feedback devices comprise a supervisor hand phone, which corresponds to the smart phone 24, an instant feedback device, which corresponds to the front-end client computer 13, and an inspector handset, which corresponds to the smart phone 24.

The web services modules 132, 134, 136 may be accessed via the network 131 by various organizational entities for processing the information that are generated by the set of management modules, the feedback module, and the maintenance module. By way of example, these organizational entities may comprise a management team, a planning team, an approving authority, a fault center operator and other users.

According to this embodiment, the set of management modules 130 and the corresponding web services module 132 may be hosted as software applications on the back end system 101 shown in FIG. 3.

According to this embodiment, the functions of the feedback system are split up in modules, as shown in FIG. 4. The organization into modules according to this embodiment is especially useful for an execution on a cloud computing system.

During execution, the load balancer 96 of the cloud computing system 93 decides how many instances of a module are required and starts or terminates one or more instances of the module on one or more physical servers.

In one embodiment, the request handling modules 132, 134, 136 comprise message buffers, which are not shown in FIG. 4. For example, the request handling module 132 stores messages from and to the administration module 137, the inventory module 138, the planning and scheduling module 139, the faults management module 140 and the handover/takeover module 141. The messages are then forwarded between the network 131 and the modules 137, 138, 139, 140, 141.

During parallel execution of the various modules, concurrency must be taken into account for data manipulations. The concurrency may be handled by the DBMS of the database 98 and/or by appropriate provisions in the software of the set of management modules 130 and/or by provisions in an intermediate software layer between the set of management modules 130 and the DBMS that is not shown in the Figures.

By way of example, FIG. 4 also shows a distribution in which the modules of FIG. 4, except for the SMS modules 143, 144, 145 are hosted on a cloud computing system 93′. In another embodiment, the SMS modules 143, 144, 145 may be hosted on the cloud computing system 93′ as well. The network 131 and/or the communication facilities for connecting to the network 131, such as the router 95 of FIG. 2, may also be regarded as part of a cloud computing system 93′, which corresponds to the cloud computing system 93 of FIG. 2. A communication data flow between the smart phone 24 and the SMS modules 143, 144, 145 and the front-end client computer and the SMS modules 143, 144 is symbolized by double arrows.

Specific portions of the set of management modules 130 of FIG. 4 correspond to the inspection server 12, the reporting server 27 and the web servers 28, 29 of FIG. 1. In one embodiment, the feedback module 133 and the maintenance module 135 correspond to the inspection server 12, which is symbolized in FIG. 4 by the dashed boundary 12′. Furthermore, the SMS modules 143, 144, 145 together with a communication apparatus that is not shown in FIG. 4, form a communication means 20′ that corresponds to the 3G modem 20 of FIG. 1. The business intelligence module 142 corresponds to a part 27a of the reporting server 27 of FIG. 1. The request handling module 132 corresponds to a part 27b of the reporting server 27 of FIG. 1.

FIGS. 5 to 15 show processes which are executed using the set of modules shown in FIG. 4. The FIGS. 5 to 15 are divided in a left side, which comprises general management processes 190, and a right side, which comprises financial transaction processes 191. The financial transaction processes 191 may be handled by a specialized bookkeeping application or finance system, which is not shown in FIG. 4. In particular, the interaction with the finance system may be handled by the update finance system applications 151 and 164 of the inventory module 138 or the handover/takeover module 141 of FIG. 4.

According to the expense tracking process of FIG. 5, an expense tracking process for a financial year is started in a starting step 192. In particular, the expense tracking process may be handled by the expense tracking application 150 of the inventory module 138 of FIG. 4.

In a first step 193, a budget for cyclical equipment assets that are due for replacement is retrieved from an asset database 194. In a second step 195, a budget for maintainable equipment assets is retrieved from the asset database 194. In a third step 196, estimated funds required for asset inventory, quotation and tender funds are retrieved from the asset database 194, from an inventory database 197 and from a contract database 198 and a total expenditure and a total budget for the financial year is generated. In a fourth step 199, an estimated total budget for the financial year is generated and corresponding information is stored in a budget database 200.

The estimated total budget is input to a decision step 201 in which it is decided, according to predetermined criteria, whether the estimated total budget is approved. In case the budget is not approved, a restriction target is generated and the process loops back to the first step 193. If the budget is approved in the decision step 201, a flag is set which indicates that the budget is set aside for the next financial year in a step 202.

According to the property information maintenance process of FIG. 6, the property information maintenance process is started in a starting step 203.

In a first step 204, a new building dataset is created and, in a first retrieving step 205, a building information is retrieved and stored in a property database 206. In a second step 207, a building unit maintenance process is started and, in a second retrieving step 208, a building unit information is retrieved and stored in the property database 206.

In a third step 208a, a lease maintenance process is started for processing leases that are related to each building unit and, in a third retrieving step 209, a leasing information is retrieved and stored in the property database 206. In a fourth step 210, a tenant details management process is started for processing tenant details information that is related to each lease and, in a fourth retrieving step 211, a tenants information is retrieved and stored in the property database 206. In an upload step 212, floor plans for each building and each unit are uploaded to the property database 206.

In an asset retrieval step 213, assets for the building or the unit to be shown, and as maintained in the asset management module are retrieved from the asset database 194. In an inventory retrieval step 214, an inventory list for each building unit is retrieved from the inventory database 197 and processed. In a fault display step 215, a defects history for a building and/or for the units of a building, as recorded in a fault reporting process, which is explained in more detail with reference to FIG. 10, is retrieved from a fault reporting database 216.

According to an inventory purchase process for a high value inventory of FIG. 7, the inventory purchase process is started in a starting step 217. In particular, the inventory purchase process may be handled by the inventory creation and management application 149 of the inventory module 138 of FIG. 4.

In a requisition step 218, a purchase requisition is raised and is stored in the inventory database 197. In another embodiment, the storing in the inventory database may also be conditioned on whether the request is approved in later steps 220, 221.

In a first approval step 219 it is decided if the finances for the purchase requisition of the requisition step are approved. If not, the purchase request is rejected in a step 220. Else, it is decided, in a second approval step 221, if the requisition of the requisition step is approved by the operational management. If not, the purchase request is rejected in a step 222. The decisions of the decision steps 219, 221 may be taken according to pre-determined criteria and/or via a user interaction over a user interface.

In a supplier selection step 223, at least three quotations are retrieved and a most suitable supplier is selected according to the quotations and the purchase requisition information is updated in a first update step 224.

In an ordering step 225, the purchase order is raised to a supplier and is stored in the inventory database 197. A purchase order information is updated in a second update step 229. In a reception step 226, a receipt from the goods supplier is updated and the stock balance of the system is updated. The goods receipt and the new stock balance are stored in the inventory database 197.

In an invoice reception step 227, an invoice is received from a supplier. In a first payment step 228, a payment is generated based on the invoice number, the supplier and the payment amount. In a second payment step 229a, the payment is made effective, for example by an electronic bank transaction.

In an inventory purchase process for a low value inventory according to FIG. 8, the inventory purchase process is started in a staring step 230. In particular, the inventory purchase process may be handled by the inventory creation and management application of the inventory module 138 of FIG. 4.

In a purchase step 231, the item is purchased from the supplier as a personal purchase and corresponding information is stored in the inventory database 197. In an update step 232, a goods receipt list from the supplier is updated and a stock balance is also updated and the updated information is stored in the inventory database 197.

In an invoice generation step 233, an invoiced is submitted through a petty cash claim. In a money retrieval step 234, the amount is claimed from a petty cash based on invoice number, supplier and payment amount. In a payment step 235, the payment is made effective.

According to an inventory withdrawal process of FIG. 9, the inventory withdrawal process is started in a starting step 236. In particular, the inventory withdrawal process may be handled by the inventory creation and management application 149 of the inventory module 138 of FIG. 4.

In a request step 237, the inventory withdrawal is requested for. In a decision step 238, it is decided if there is sufficient stock available for the inventory withdrawal. If not, the stock level is increased according to the inventory procurement process of FIG. 7 or FIG. 8 in step 239. Then, the withdrawal procedure is repeated, for example by looping back to the decision step 238.

If it is decided, in the decision step 238, that there is a sufficient amount of stock available, a withdrawal request to withdraw from the stock is created in a withdrawal request step 240 and the withdrawal request is stored in the inventory database 197. In a computation step 241, a new stock balance is computed and stored in the inventory database.

According to a fault reporting process of FIG. 10, the fault reporting process is started in a starting step 242. In particular, the fault reporting may be handled by the fault reporting application 170 of the feedback module 133 of FIG. 4.

A receipt message is generated and stored in the fault reporting database 216 in a reception step 243. Relevant information that pertains to the building or building unit to which the fault report refers is retrieved from the asset database 194 and from the property database 206 and the affected asset or building is selection in a step 245. In a determination step 246, a fault category is determined based on the fault report and the information that has been retrieved from the databases 194, 206.

In a first fault management step 247, the fault report is assigned to a department or unit for follow up action. A notice via SMS or E-mail is sent to activate the staff of the assigned department or unit. The time since receipt of the fault report is monitored. If it is determined that the fault is not rectified within a deadline in a priority timeline, an escalation process is started in which E-Mails or SMSs are sent to respective supervisors. In particular, the escalation may be handled by the escalation monitoring application 157 of the planning and scheduling module 139 or also by the escalation monitoring application 162 of FIG. 4.

As a further measure, data sets of staff members who are on leave are retrieved from a staff database 248. The staff members on leave are prompted if they are selected for activation. This may be indicated by a flag in the staff database 248. The actions that are taken in the first fault management step, like sending of the messages via SMS or E-Mail and the escalation steps are stored in the fault reporting database 244.

In a second fault management step 249, information from an internal staff inspection using handheld devices is received and the actual arrival and completion time is tracked, for example through barcode scanning at the defects location. These actions are recorded in the fault reporting database 244. The staff determines an action to be taken, based on the nature of the defect and initiates one or more of the below mentioned action steps. In particular, information from the handheld devices for the process of FIG. 10 and for other processes of FIGS. 5 to 15 may be processed by the maintenance module 135 of FIG. 4.

In a first action step 250, contractors are activated and a works order or and instruction order is issued. The creation of a work order or instruction order is explained in more detail with reference to FIG. 11. In a second action step 251, inventory items are withdrawn according to the process of FIG. 9. In a third action step 252, it is determined that the fault can be resolved by the internal staff of the facility and a corresponding message is issued. In a fourth action step 253, the task is assigned to a different department or unit and the process loops back to the first fault management step 247.

The action steps 250, 251, 252, 253 are in general alternative steps, but especially the actions steps 250, 251, 252 may also be combined. In a completion step 254, an information is received that the repair job has been done and corresponding information that the fault or complaint case is closed is stored in the fault reporting database 244. In a report generation step 255, an analytical report is generated in order to track the fault reporting statistics and the contractor performance.

According to a work order creation process of FIG. 11, a work order/instruction order process is started in a starting step 256. In particular, the work order creation process may be handled by the maintenance program creation and management application 153 of the planning and scheduling module 139 of FIG. 4.

A work order/instruction order dataset is created in a dataset creation step 257 and stored in a work order instruction order database 258. In a first selection step 259, data for an asset or building with defects is retrieved from the property database 206 and/or the database 194 based on the work/instruction order of step 257. In a second selection step 260 term contractor which has active contracts for this term is selected to perform the works and corresponding contract information is received from the contract database 198. In an update step 261, schedule or rate items that are used in the work order are updated and stored in the work/instruction order database 258.

In a sending and receiving step 262, actual arrival and completion times are received and entered by the contractor through use of barcode scanning at the defects location. In a tracking step 263, the warranty of the works order/instruction order is tracked and, in a rating step 264, the contractors are rated according to pre-determined criteria and/or by manual entry through a user interface. In a completion step 265, the work/instruction order is closed. In a certification step 266, the works order is certified. In a reporting step 267, analytical reports are generated in order to track contractor performance and work/instruction order reports. In a step 268, a payment for the work order is executed. The step 268 is explained in more detail with reference to the following FIG. 12.

According to a contractor selection and payment process of FIG. 12, a contract management process is started in a starting step 269. In particular, the contractor selection and payment process may be handled, among others, by the maintenance program creation and management application 153 of the planning and scheduling module 139 and the spares budget and expense tracking application 150 of the inventory module 138 of FIG. 4.

In a dataset creation step 270, a dataset for a new quotation or for a new tender is created and stored in the contract database 198. In a maintenance step 271, the required schedule of rates items are retrieved and processed. In a notification step 272, contractors are invited for bidding during a contract open period. In a registration step 273, all participating contractors and their bid amounts are registered and stored in the contract database 198. In a selection step 274, a most suitable contractor is selected and contract data is generated including a contract sum, a reference number and further contractor information in a first contract generation step 275.

In a schedule determination step 276, it is determined if an extension of time is required and the corresponding information is stored in the contract database. In a first determination step 277, it is determined if a variation order is required. If a variation order is required, the contract information is updated with a variation amount, a reference number and further contract information in a second contract generation step 278. If no variation order is required it is determined, in a second determination step 279, if there are liquidated damages. If there are liquidated damages, the contract information is updated with a liquidated damages amount, a reference number and contractor information in a third contract generation step 280. If it is determined that there are no liquidated damages, a payment to the contractors is generated in a payment generation step 281. The payment is based on a certified works order such as progressive payment, penultimate payment, retention money etc.

In a funds determination step 282 it is determined if the funds are sufficient for payment of the contractor. If funds are not sufficient, the payment to the contractor is readjusted and the step 281 is repeated. If it is determined that there are sufficient funds, a payment is generated based on invoice number, reference number and payment amount in a payment generation step 283 and the payment is processed in a payment processing step 284.

In a balance generation step 285, a new contract balance is calculated and stored in stored in the contract database. In a closing step, the quotation or tender is closed upon completion 286. In a reporting step 287, analytical reports to track contractor performance, a contract summary and a detailed report are generated.

In an asset management process according to FIG. 13, the asset management process is started in a starting step 288. In particular, the asset management process may be handled, among others, by the maintenance program and creation application 153 of the planning and scheduling module 139 of FIG. 4.

In an asset creation step 289, a new asset dataset is created and corresponding information for the asset such as the association to a particular building or unit and whether the asset is maintainable or intended for cyclical use is retrieved, processed and stored in the asset database 194. In a first maintenance step 290, asset information, such as estimated lifespan, warranty period, serial number, purchase cost and date, is registered and stored in the asset database. In a second maintenance step 291, information concerning the components in the asset are registered and stored in the asset database.

In an alerting step 292, asset information is retrieved from the asset database and an alert is sent through E-mail or SMS if a service level agreement is not met, for example if the number of breakdowns that were tracked in a fault reporting exceeded a pre-determined number of breakdowns that was stated in technical specifications.

In a report generation step 293, an analytical report to track asset listings and a detailed reporting is generated. In a maintenance information retrieval step 294, information about the last preventive maintenance date and the next maintenance data are retrieved from a preventive maintenance database 295 and are displayed on a display.

According to a preventive maintenance process for an asset FIG. 14, a preventive maintenance process is started in a starting step 296. In particular, the preventive maintenance process may be executed by the maintenance module 135 of FIG. 4.

In a first maintenance step 297, a checklist item to be used is retrieved and stored in the preventive maintenance database 295. In a second maintenance step 298, a checklist to be used is retrieved and stored in the preventive maintenance database. In a schedule generation step 299, a schedule is generated for routine maintenance of assets in a building. The schedule may be daily, weekly, monthly, bi-monthly or otherwise. For generating the schedule, information is retrieved from the asset database 194. The schedule is stored in the preventive maintenance database 295. In a notification step 300, reminders are sent via E-mail or SMS before the scheduled day of maintenance.

In a tracking step 301, the results of an inspection using handheld devices with the designated checklist on the designated scheduled date are retrieved. Actual arrival and completion times are tracked through barcode scanning at the inspection location. In a similar way as mentioned for FIG. 1, an escalation process is started if an inspection is not done after a scheduled date, the escalation comprising sending messages via E-Mail or SMS to respective supervisors.

In a decision step 302, it is decided if defects are found. If there is a feedback message that defects are found, a new fault message for the affected asset is generated in a step 303 and the process loops to the fault reporting process of FIG. 10 in a step 304. After completing the fault reporting process, the inspection schedule is completed or closed in a step 305. If no defects are reported, the inspection schedule is completed or closed in the step 305. In a notification step, an update of the inspection results is sent via a wireless connection in a notification step 306.

According to a preventive maintenance process for services of FIG. 15, a preventive maintenance process is started in a starting step 307. In particular, the preventive maintenance process may be executed by the maintenance module 135 of FIG. 4.

In a first maintenance step 308, a checklist item to be used is retrieved and stored in the preventive maintenance database 295. In a second maintenance step 309, a checklist to be used is retrieved and stored in the preventive maintenance database 295. In a schedule generation step 310, a schedule is generated for services in a building. The schedule may be daily, weekly, monthly, bi-monthly or otherwise. For generating the schedule, information is retrieved from the property database 194. The schedule is stored in the preventive maintenance database 295. In a notification step 311, reminders are sent via E-mail or SMS before the scheduled day of maintenance.

In a tracking step 312, the results of an inspection using handheld devices with the designated checklist on the designated scheduled date are retrieved. Actual arrival and completion times are tracked through barcode scanning at the inspection location. In a similar way as mentioned for FIG. 1, an escalation process is started if an inspection is not done after a scheduled date, the escalation comprising sending messages via E-Mail or SMS to respective supervisors.

In a decision step 313, it is decided if defects are found. If a feedback message has been received that defects are found, a new fault message for the affected asset is generated in a step 314 and the process loops to the fault reporting process of FIG. 10 in a step 315. After completing the fault reporting process, the inspection schedule is completed or closed in a step 316. If no defects are reported, the inspection schedule is completed or closed in the step 316. In a notification step 317, an update of the inspection results is sent via a wireless connection.

The asset database 194, inventory database 197, contract database 198, budget database 200, fault reporting database 216, work/instruction order database 258 and the preventive maintenance database 295 may be comprised in a single database or in several databases. In general, a database may refer to a data storage which is managed by a database management system, such as a relational database management system, or also to a data storage that is managed by specific computer executable code for coordinating accesses and modification of the data in the data storage.

FIG. 16 shows a hardware block diagram 360 of the integrated feedback management system of FIG. 2. The block diagram 360 shows a cloud computing system 363 that is communicatively connected to multiple channels 365 for disseminating information.

The cloud computing system 363 includes a business intelligence application server 367 that is connected to a plurality of data servers and to a plurality of communication servers.

The data servers include an instant feedback server 369 and a data inspection server 372 that are connected a data integration application server 374. The data integration application server 374 is connected to a data warehouse server 376, which is connected to the business intelligence application server 367. Multiple external systems and data sources 399 are also connected to the data integration application server 374.

The communication servers include a business to business (B2B) partner portal interface 401, a web server 403, a mobile server 405, and a content management system 408. The partner portal interface 401, the web server 403, the mobile server 405, and the content management system 408 are connected to the business intelligence application server 367.

The channels comprise a partner portal 411, a computer 413, a mobile computing device 415, such as a mobile smart phone and a mobile computer with a touchscreen, and a display monitor 417, such a television screen. In particular, the partner portal 411 is connected to the partner portal interface 401. The computer 413 is connected to the web server 403. The mobile computing device 415 is connected to the mobile server 405.

The display monitor 417 is connected to the content management system 408.

The inspection is server computer is provided by a cloud computing system. The cloud computing system comprises a network of computers. These computers provide a significant portion of the hardware and software support functions of the outsource facility management services. The client computer may need to perform only light functions, such as web browsing, since the rest of the functions are taken up by the cloud computing system.

In use, the cloud computing system 363 provides hardware and software support functions.

The instant feedback server 369 receives information, such as service comments, from instant feedback devices and later transmits the information to the data integration application server 374.

The data inspection server 372 provides inspection data list of a site to a supervisor and receives a site inspection data of the site from the supervisor. The data inspection server 372 then transmits the inspection data to the data integration application server 374.

The data integration application server 374 sends the received information to the data warehouse server 376 for storing. The business intelligence application server 367 then retrieves the information from the data warehouse server 376 and generates business intelligence reports from the information for sending to the communication servers, which show the reports to different users.

In particular, the partner portal 411 sends the business intelligence reports to the partner portal interface 401 for receiving by business partners. The web server 403 sends the business intelligence reports to the computer 413 while the content management system 408 sends the business intelligence reports to the display monitor 417.

FIG. 17 shows a software block diagram 500 of the integrated feedback management system of FIG. 2 for managing services of a facility, such an airport.

The block diagram 500 shows a cloud computing system 503 that is communicatively connected to touch screen devices 505, to mobile computing devices 507, such as portable computers and smart hand phones.

The cloud computing system 503 has front-end software modules 510 and supervisor software modules 512.

The front-end software modules 510 include an instant feedback module 514, a fault report module 516, a fault clearing module 518, and a call for supervisor module 520.

The supervisor software modules 512 include a real-time monitoring module 522, an ad hoc report module 524, a staff administration module 526, and a devices administration module 528.

In use, the touch screen devices 505 receive feedback and comments from the public and passengers. The instant feedback module 514 receives the feedback and the comments from the touch screen devices 505.

The fault report module 516 allows service personnel to report faults, such as broken wash basin tap, via the touch screen devices 505. The fault clearing module 516 serves to inform maintenance persons via the module computing devices 507 of the reported faults and for receiving notification of the rectification of the faults.

The call for supervisor module 520 allows the public and the passengers to request supervisors via the touch screen devices 505 to address service concerns. The real time monitoring module 522 provides alerts in event of excursion of services.

The cloud computing system 503 also provides management of inspection services 532 and business reports 534.

FIG. 18 shows embodiment of the cloud computing system of FIG. 2. FIG. 18 shows a cloud computing system 650.

The cloud computing system 650 includes a load balancer 653 with two computer resources 655. The load balancer 653 and the computer resources 655 are connected to an Internet protocol communication line 657.

In particular, the load balancer 653 has an Internet protocol port 660 that is connected to the Internet protocol communication line 657.

Each computer resource 655 has a processor 663 that is connected to an Internet protocol port 667 and to a memory unit 669. The memory unit 669 has a plurality of memory segments 671. The Internet protocol port 667 is connected to the Internet protocol communication line 657.

In use, the load balancer 653 receives computing requests from client terminal computers. The load balancer 653 then assigns the computing requests to the computer resources 655 via the port 660.

Referring to the computer resources 655, they act as computing devices that store data and manipulate the stored data.

The port 667 receives the computing requests from the load balancer unit using Internet protocol.

The processor 663 responds the computing requests according the instructions of programs that are stored in the memory segments 671. The programs allow the computer resource 655 to act as an inspection server, a reporting server, or a web server. Put differently, the computer resource serves as an virtual inspection server, a virtual reporting server, and a virtual web server.

Each memory segment 671 serves to store one or more programs. A program that is stored in one memory segment can be similar to or same as another program that is stored in another memory segment.

In other words, one computer resource 655 can act as several virtual servers for responding various computing requests from the load balancer 653. The load balancer 653 selects the computer resource 655 and the virtual server of the computer resource 655 for allocating the computing request in order to balance the computing burden or load of the computing request.

The embodiments can also be described with the following lists of features or elements being organized into items. The respective combinations of features, which are disclosed in the item list, are regarded as independent subject matter, respectively, that can also be combined with other features of the application.
1. A system for supporting facilities management services,
   the system comprising
      at least one client terminal computer comprising a display device, at least one corresponding tactile input device, and a client wireless communication module,
      at least one mobile computing device, and
      an Inspection server computer comprising an Inspection server computer wireless communication module for communicating with the at least one client terminal computer, further comprising an Inspection server computer wireless phone module for communicating with the at least one mobile computing device, and further comprising a pre-determined set of inspection data lists,
   wherein the system provides a user feedback data acquisition mode, an alert mode, and a site inspection mode, such that
   in the user feedback data acquisition mode,
      the client terminal computer provides a predetermined set of user feedback messages on the display device, and upon receiving a user input into the tactile input device, the client terminal computer issues a pre-determined user feedback message over the client wireless communication module, and
      the Inspection server computer receives the predetermined user feedback message from the at least one client terminal computer over the Inspection server computer wireless communication module and checks the user feedback message whether it indicates a user alert, wherein the system enters into the alert mode, if the Inspection server computer identifies that the user feedback message indicates a user alert,
   in the alert mode,
      the Inspection server computer issues an alert message over the Inspection server computer wireless phone module for instructing a supervisor to proceed to the at least one client terminal computer that has issued the respective user feedback message that indicates a user alert, and
   in the inspection mode,
      the Inspection server computer selects one inspection data list from the set of inspection data lists and issues the inspection data list over the Inspection server computer wireless phone module,
      the mobile computing device reads in pre-determined location information data that corresponds to the inspection data list,
      the mobile computing device receives site inspection data,
      the mobile computing device issues a site data message containing the location information data and the site inspection data to the Inspection server computer, and
      the Inspection server computer receives the site data message containing the location information data and the site inspection data, and
   wherein the Inspection server computer is provided by a cloud computing system.
2. The system according to item 1, wherein
   in the alert mode,
      the mobile computing device reads in a location information data at the least one client terminal computer that has issued the respective user feedback message that indicates a user alert,
      the mobile computing device issues a site data message containing the location information data, and
      the Inspection server computer receives the site data message containing the location information data.
3. The system according to item 1 or item 2, wherein
   in the alert mode,
      the at least one client terminal computer receives phone identity data relating to the mobile computing device that has received the alert message,
      the at least one client terminal computer issues a data message containing the phone identity data, and
      the Inspection server computer receives the data message containing the phone identity data.
4. The system according to one of the aforementioned items, wherein
   the mobile computing device provides audio communication capabilities with other mobile computing devices.
5. The system according to one of the aforementioned items, wherein
   the Inspection server computer stores the received data for evaluation purposes.
6. The system according to item 5, wherein
   the Inspection server computer forwards the stored received data to a reporting server computer.
7. The system according to item 6, wherein
   the reporting server computer is provided by a cloud computing system.
8. The system according to one of the aforementioned items, wherein
   the mobile computing device comprises a text data input device.
9. The system according to one of the aforementioned items, wherein
   the mobile computing device and the Inspection server computer wireless phone module each comprises a WLAN communication module.
10. The system according to one of the aforementioned items, wherein
   the mobile computing device and the Inspection server computer wireless phone module each comprises a GSM communication module.
11. The system according to one of the aforementioned items, wherein
   the alert message is sent in an SMS format.
12. The system according to one of the aforementioned items, wherein
   the client wireless communication module and the Inspection server computer wireless communication module each comprises a WLAN communication module.
13. The system according to one of the aforementioned items, wherein
   the client wireless communication module and the Inspection server computer wireless communication module each comprises a GSM communication module.
14. The system according to one of the aforementioned items, wherein
   messages between the Inspection server computer and the at least one client terminal computer are transmitted in an SMS format.
15. The system according to one of the aforementioned items, wherein
   the inspection data list comprises blank data fields for receiving the site inspection data, wherein the site data message comprises the inspection data list and the site inspection data.
16. The system according to one of the aforementioned items, wherein
   the mobile computing device comprises a camera being configured as a Bar code reader.
17. The system according to one of the aforementioned items, wherein
   the client terminal computer further comprising a client memory unit for storing client data, the client data is provided for transmitting to the Inspection server computer, and
   the Inspection server computer further comprising a client memory unit for storing server data, the server data is provided for transmitting to the client terminal computer.
18. A method for operating a management service, the method comprising
   the management service providing a user feedback data acquisition service, an alert service, and a site inspection service,
   wherein the user feedback data acquisition service comprises
      a client terminal computer providing a predetermined set of user feedback messages, upon receiving a user input, the client terminal computer issues a pre-determined user feedback message, and
      an Inspection server computer receiving the predetermined user feedback message from the client terminal computer and checking the user feedback message whether it indicates a user alert, wherein the management service changes to provide the alert service, if the Inspection server computer identifies that the user feedback message indicates a user alert,
   wherein the alert service comprises
      the Inspection server computer issuing an alert message to a mobile computing device for instructing a supervisor to proceed to the client terminal computer that has issued the user feedback message that indicates the user alert,
   wherein the inspection service comprises
      the Inspection server computer selecting one inspection data list from a set of inspection data lists and issuing the inspection data list to the mobile computing device for instructing a supervisor,
      the mobile computing device reading in a predetermined location information data that corresponds to the inspection data list,
      the mobile computing device receiving site inspection data,
      the mobile computing device issuing a site data message containing the location information data and the site inspection data to the Inspection server computer, and
      the Inspection server computer receiving the site data message containing the location information data and the site inspection data, and
   wherein the inspection service is provided by a cloud computing system.
19. The method according to item 18,
   wherein the alert service further comprises
      the mobile computing device reading in a location information data at the client terminal computer that has issued the user feedback message that indicates a user alert,
      the mobile computing device issuing a site data message containing the location information data, and
      the Inspection server computer receiving the site data message containing the location information data.
20. The method according to item 18 or item 19, wherein
   the alert service further comprises
      the client terminal computer receiving phone identity data relating to the mobile computing device that has received the alert message,
      the client terminal computer issuing a data message containing the phone identity data, and
      the Inspection server computer receiving the data message containing the phone identity data.
21. The method according to one of items 18 to 20 further comprising
   the Inspection server computer storing the received data.
22. The method according to item 21 further comprising
   the Inspection server computer forwarding the stored received data to a reporting server computer.
23. The method according to item 22, wherein
   the reporting server computer is provided by a cloud computing system.
24. The method according to one of items 18 to 23, wherein
   the user feedback data acquisition service further comprises
      the client terminal computer storing the predetermined user feedback message and
      the Inspection server computer receiving the predetermined user feedback message from the client terminal computer when a communication link between the client terminal computer and the Inspection server computer is established.
25. A system for supporting facilities management services,
   the system comprising
      at least one client terminal computer comprising a display device, at least one corresponding tactile input device, and a client wireless communication module,
      at least one mobile computing device,
      an Inspection server computer wireless communication module for communicating with the at least one client terminal computer and for communicating with an Inspection server computer, and
      an Inspection server computer wireless phone module for communicating with the at least one mobile computing device and for communicating with the Inspection server computer,
   wherein the system provides a user feedback data acquisition mode, an alert mode, and a site inspection mode, such that
   in the user feedback data acquisition mode,
      the client terminal computer provides a predetermined set of user feedback messages on the display device, and upon receiving a user input into the tactile input device, the client terminal computer issues a pre-determined user feedback message over the client wireless communication module, and
      the Inspection server computer wireless communication module receives the pre-determined user feedback message from the at least one client terminal computer and transmits the pre-determined user feedback message to the Inspection server computer,
   in the alert mode,
      the Inspection server computer wireless phone module receives an alert message from the Inspection server computer and issues the alert message for instructing a supervisor to proceed to the at least one client terminal computer that has issued the respective user feedback message that indicates a user alert, and
   in the inspection mode,
      the Inspection server computer wireless phone module receives an inspection data list from the Inspection server computer and issues the inspection data list,
      the mobile computing device reads in pre-determined location information data that corresponds to the inspection data list,
      the mobile computing device receives site inspection data,
      the mobile computing device issues a site data message containing the location information data and the site inspection data to the Inspection server computer wireless phone module, and
      the Inspection server computer wireless phone module receives the site data message containing the location information data and the site inspection data and transmits the site data message containing the location information data and the site inspection data to the Inspection server computer.
26. The system according to item 25, wherein
   in the alert mode,
      the mobile computing device reads in a location information data at the least one client terminal computer that has issued the respective user feedback message that indicates a user alert,
      the mobile computing device issues a site data message containing the location information data, and
      the Inspection server computer wireless phone module receives the site data message containing the location information data and transmits the site data message containing the location information data to the Inspection server computer.
27. The system according to item 25 or item 26, wherein
   in the alert mode,
      the at least one client terminal computer receives phone identity data relating to the mobile computing device that has received the alert message,
      the at least one client terminal computer issues a data message containing the phone identity data, and
      the Inspection server computer wireless communication module receives the data message containing the phone identity data and transmits the data message containing the phone identity data to the Inspection server computer.
28. The system according to one of items 25 to 27, wherein
   the mobile computing device provides audio communication capabilities with other mobile computing devices.
29. The system according to one of items 25 to 28, wherein
   the mobile computing device comprises a text data input device.
30. The system according to one of items 25 to 29, wherein
   the mobile computing device and the Inspection server computer wireless phone module each comprises a WLAN communication module.
31. The system according to one of items 25 to 30, wherein
   the mobile computing device and the Inspection server computer wireless phone module each comprises a GSM communication module.
32. The system according to one of items 25 to 31, wherein
   the alert message is sent in an SMS format.
33. The system according to one of items 25 to 32, wherein
   the client wireless communication module and the Inspection server computer wireless communication module each comprises a WLAN communication module.
34. The system according to one of items 25 to 33, wherein
   the client wireless communication module and the Inspection server computer wireless communication module each comprises a GSM communication module.
35. The system according to one of items 25 to 34, wherein
   messages between the Inspection server computer wireless communication module and the at least one client terminal computer are transmitted in an SMS format.
36. The system according to one of items 25 to 35, wherein
   the inspection data list comprises blank data fields for receiving the site inspection data, wherein the site data message comprises the inspection data list and the site inspection data.
37. The system according to one of items 25 to 36, wherein
   the mobile computing device comprises a camera being configured as a Bar code reader.
38. The system according to one of items 25 to 37, wherein
   the client terminal computer further comprising a client memory unit for storing client data, the client data is provided for transmitting to the Inspection server computer wireless communication module.
39. A method for operating a management service, the method comprising
   the management service providing a user feedback data acquisition service, an alert service, and a site inspection service,
   wherein the user feedback data acquisition service comprises
      a client terminal computer providing a predetermined set of user feedback messages, upon receiving a user input, the client terminal computer issues a pre-determined user feedback message, and
      an Inspection server computer wireless communication module receiving the pre-determined user feedback message from the client terminal computer and transmitting the pre-determined user feedback message to an Inspection server computer,
   wherein the alert service comprises
      the Inspection server computer wireless phone module receiving an alert message from the Inspection server computer and issuing the alert message to a mobile computing device for instructing a supervisor to proceed to the client terminal computer that has issued the user feedback message that indicates the user alert,
   wherein the inspection service comprises
      the Inspection server computer wireless phone module receiving an inspection data list and issuing the inspection data list to the mobile computing device for instructing a supervisor,
      the mobile computing device reading in a predetermined location information data that corresponds to the inspection data list,
      the mobile computing device receiving site inspection data,
      the mobile computing device issuing a site data message containing the location information data and the site inspection data to the Inspection server computer wireless phone module, and
      the Inspection server computer wireless phone module receiving the site data message containing the location information data and the site inspection data and transmitting the site data message containing the location information data and the site inspection data to the Inspection server computer.
40. The method according to item 39,
   wherein the alert service further comprises
      the mobile computing device reading in a location information data at the client terminal computer that has issued the user feedback message that indicates a user alert,
      the mobile computing device issuing a site data message containing the location information data, and
      the Inspection server computer wireless phone module receiving the site data message containing the location information data and transmitting the site data message containing the location information data to the Inspection server computer.
41. The method according to item 39 or item 40, wherein
   the alert service further comprises
      the client terminal computer receiving phone identity data relating to the mobile computing device that has received the alert message,
      the client terminal computer issuing a data message containing the phone identity data, and
      the Inspection server computer wireless communication module receiving the data message containing the phone identity data and transmitting the data message containing the phone identity data to the Inspection server computer.
42. The method according to one of items 39 to 41, wherein
   the user feedback data acquisition service further comprises
      the client terminal computer storing the predetermined user feedback message and
      the Inspection server computer wireless communication module receiving the pre-determined user feedback message from the client terminal computer and transmitting the pre-determined user feedback message to the Inspection server computer when a communication link between the client terminal computer and the Inspection server computer wireless communication module is established.

Although the above description contains much specificity, this should not be construed as limiting the scope of the embodiments but merely providing illustration of the foreseeable embodiments. In particular, the above stated aspects of the embodiments should not be construed as limiting the scope of the embodiments but merely to explain possible achievements if the described embodiments are put into practice. Thus, the scope of the embodiments should be determined by the claims and their equivalents, rather than by the examples given.

### REFERENCE NUMBERS

10 feedback management system
10′ feedback management system
12 inspection server
12′ inspection server
13 front-end client computer
15 touch screen
17 antenna
18 RFID card reader
19 communication module
20 3G modem
20′ modem and router
21 communication module
22 antenna
23 communication module
24 smart phone
25 camera
28 computer
27 reporting server
27′ reporting server
27a a part of the reporting server
27b a part of the reporting server
39 computer
29′ web server
30 3G modem
35 supervisor module server
35′ supervisor module server
37 front-end client computer
39 supervisor screen
40 router
41 WLAN antenna
42 touch screen
43 POS terminal
45 screen icon
46 screen icon
50 alert
52 report
54 checklist
56 report
58 feedback management system
60 client computer
60′ client computer
62 RFID reader
65 state diagram
67 state
69 state
71 state
73 state
80 state diagram
82 state
83 state
85 state
87 state
88 integrated feedback management system
89 integrated feedback management system
90 server memory module
92 computer memory module
93 cloud computing system
93′ cloud computing system
94 network
95 router
96 load balancer
97 computing resources
98 data storage
99 output device
100 communication infrastructure
101 back end system
102 first communication gateway
103 second communication gateway
104 internet
105 3G private network
106 firewall
107 first interface
108 second interface
109 third interface
110 fourth interface
111 GGSN
112 second firewall
113 front-end system
114 tenant interface
115 GHA interface
116 ICA interface
117 janitorial inspection interface
118 customs office interface
119 monitoring system
120 supervisor
121 administrator
122 first interface
123 second interface
124 first server
125 second server
126 data synchronization server
127 network
130 set of management modules
131 communication network
132 request handling module
133 feedback module
134 request handling module
135 maintenance module
136 request handling module
137 administration module
138 inventory module
139 planning and scheduling module
140 faults management module
141 handover/takeover module
142 business information module
143 SMS module
144 SMS module
145 SMS module
146 user creation and management module
147 equipment location and tag management application
148 database manage management application
149 inventory creation and management application
150 expense tracking application
151 system updating application
152 checklist creation and management application
153 maintenance program creation and management application
154 SMS reminder application
155 case creation and management application
156 fault status monitoring application
157 alerting and escalation application
158 report generation application
159 history and trend analysis application
160 tenant creation and management application
161 fault status application
162 escalation monitoring application
163 utilities computation application
164 finance system updating application
165 login application
166 data synchronization application
167 staff pass code scanning application
168 first and second level feedback application
169 feedback status and update application
170 faults reporting application
171 login application
172 data synchronization application
173 barcode handling application
174 service checking application
175 photo handling application
176 fault reporting and status update application
190 general management processes
191 financial transaction processes
192 starting step
193 first step
194 asset database
195 second step
196 third step
197 inventory database
198 contract database
199 fourth step
200 budget database
201 decision step
202 step
203 starting step
204 first step
205 first retrieving step
206 property database
207 second step
208 second retrieving step
208a third step
209 third retrieving step
210 fourth step
211 fourth retrieving step
212 upload step
213 asset retrieval step
214 inventory retrieval step
215 fault display step
216 fault reporting database
217 starting step
218 requisition step
219 first approval step
220 step
221 second approval step
222 step
223 supplier selection step
224 first update step
225 ordering step
226 reception step
227 invoice reception step
228 first payment step
229 second update step
229a second payment step
230 staring step
231 purchase step
232 update step
233 invoice generation step
234 money retrieval step
235 payment step
236 starting step
237 request step
238 decision step
239 step
240 withdrawal request step
241 computation step
242 starting step
243 reception step
245 step
246 determination step
247 first fault management step
248 staff database
249 second fault management step
250 first action step
251 second action step
252 third action step
253 fourth action step
254 completion step
255 report generation step
256 starting step
257 dataset creation step
258 work order instruction order database
259 first selection step
260 second selection step
261 update step
262 sending and receiving step
263 tracking step
264 rating step
265 completion step
266 certification step
267 reporting step
268 step
269 starting step
270 dataset creation step
271 maintenance step
272 notification step
273 registration step
274 selection step
275 first contract generation step
276 schedule determination step
277 first determination step
278 second contract generation step
279 second determination step
280 third contract generation step
281 payment generation step
282 funds determination step
283 payment generation step
284 payment processing step
285 balance generation step
286 closed upon completion
287 reporting step
288 starting step
289 asset creation step
290 first maintenance step
291 second maintenance step
292 alerting step
293 report generation step
294 maintenance information retrieval step
295 preventive maintenance database
296 starting step
297 first maintenance step
298 second maintenance step
299 schedule generation step
300 notification step
301 tracking step
302 decision step
303 step
304 step
305 step
306 notification step
307 starting step
308 first maintenance step
309 second maintenance step
310 schedule generation step
311 notification step
312 tracking step
313 decision step
314 step
315 step
316 step
317 notification step
360 feedback management system
363 cloud computing system
365 multiple channels
367 business intelligence application server
369 instant feedback server
372 data inspection server
374 data integration application server
376 data warehouse server
399 Multiple external systems and data sources
401 B2B partner portal interface
403 web server
405 mobile server
408 content management system
411 partner portal
413 computer
415 mobile computing device
417 display monitor
500 software block diagram
503 cloud computing system
505 touch screen device
507 mobile computing device
510 front-end software modules
512 supervisor software modules
514 instant feedback module
516 fault report module
518 fault clearing module
520 0call for supervisor module
522 real-time monitoring module
524 ad hoc report module
526 staff administration module
528 devices administration module
532 inspection service
534 business report
650 cloud computing system
653 load balancer
655 computer resource
657 Internet protocol communication line
660 Internet protocol port
663 processor
667 Internet protocol port
669 memory unit
671 memory segment

1. A system for supporting facilities management services, the system comprising
at least one client terminal computer comprising a display device, at least one corresponding tactile input device, and a client wireless communication module,
at least one mobile computing device, and
an Inspection server computer comprising an Inspection server computer wireless communication module for communicating with the at least one client terminal computer, further comprising an Inspection server computer wireless phone module for communicating with the at least one mobile computing device, and further comprising a pre-determined set of inspection data lists,
wherein the system provides a user feedback data acquisition mode, an alert mode, and a site inspection mode, such that
in the user feedback data acquisition mode,
the client terminal computer provides a pre-determined set of user feedback messages on the display device, and upon receiving a user input into the tactile input device, the client terminal computer issues a pre-determined user feedback message over the client wireless communication module,
the Inspection server computer receives the pre-determined user feedback message from the at least one client terminal computer over the Inspection server computer wireless communication module and checks the user feedback message whether it indicates a user alert, wherein the system enters into the alert mode, if the Inspection server computer identifies that the user feedback message indicates a user alert,
in the alert mode,
the Inspection server computer issues an alert message over the Inspection server computer wireless phone module for instructing a supervisor to proceed to the at least one client terminal computer that has issued the respective user feedback message that indicates a user alert, and
in the inspection mode,
the Inspection server computer selects one inspection data list from the set of inspection data lists and issues the inspection data list over the Inspection server computer wireless phone module,
the mobile computing device reads in pre-determined location information data that corresponds to the inspection data list,
the mobile computing device receives site inspection data,
the mobile computing device issues a site data message containing the location information data and the site inspection data to the Inspection server computer, and
the Inspection server computer receives the site data message containing the location information data and the site inspection data, and
wherein the Inspection server computer is provided by a cloud computing system.

2. The system according to claim 1, wherein in the alert mode,
the mobile computing device reads in a location information data at the least one client terminal computer that has issued the respective user feedback message that indicates a user alert,
the mobile computing device issues a site data message containing the location information data, and
the Inspection server computer receives the site data message containing the location information data.

3. The system according to claim 1, wherein in the alert mode,
the at least one client terminal computer receives phone identity data relating to the mobile computing device that has received the alert message,
the at least one client terminal computer issues a data message containing the phone identity data, and
the Inspection server computer receives the data message containing the phone identity data.

4. The system according to claim 1, wherein the mobile computing device provides audio communication capabilities with other mobile computing devices.

5. The system according to claim 1, wherein the Inspection server computer stores the received data for evaluation purposes and forwards the stored received data to a reporting server computer, and wherein the reporting server computer is provided by a cloud computing system.

6-7. (canceled)

8. The system according to claim 1, wherein the mobile computing device comprises a text data input device.

9. The system according to claim 1, wherein the mobile computing device and the Inspection server computer wireless phone module each comprises a WLAN communication module.

10. The system according to claim 1, wherein the mobile computing device and the Inspection server computer wireless phone module each comprises a GSM communication module.

11. The system according to claim 1, wherein the alert message is sent in an SMS format.

12. The system according to claim 1, wherein the client wireless communication module and the Inspection server computer wireless communication module each comprises a WLAN communication module.

13. The system according to claim 1, wherein the client wireless communication module and the Inspection server computer wireless communication module each comprises a GSM communication module.

14. The system according to claim 1, wherein messages between the Inspection server computer and the at least one client terminal computer are transmitted in an SMS format.

15. The system according to claim 1, wherein the inspection data list comprises blank data fields for receiving the site inspection data, wherein the site data message comprises the inspection data list and the site inspection data.

16. The system according to claim 1, wherein the mobile computing device comprises a camera being configured as a Bar code reader.

17. The system according to claim 1, wherein the client terminal computer further comprising a client memory unit for storing client data, the client data is provided for transmitting to the Inspection server computer and the Inspection server computer further comprising a client memory unit for storing server data, the server data is provided for transmitting to the client terminal computer.

18. A method for operating a management service, the method comprising:
the management service providing a user feedback data acquisition service, an alert service, and a site inspection service,
wherein the user feedback data acquisition service comprises
a client terminal computer providing a pre-determined set of user feedback messages, upon receiving a user input, the client terminal computer issues a predetermined user feedback message, and
an Inspection server computer receiving the pre-determined user feedback message from the client terminal computer and checking the user feedback message whether it indicates a user alert, wherein the management service changes to provide the alert service, if the Inspection server computer identifies that the user feedback message indicates a user alert,
wherein the alert service comprises
the Inspection server computer issuing an alert message to a mobile computing device for instructing a supervisor to proceed to the client terminal computer that has issued the user feedback message that indicates the user alert,
wherein the inspection service comprises
the Inspection server computer selecting one inspection data list from a set of inspection data lists and issuing the inspection data list to the mobile computing device for instructing a supervisor,
the mobile computing device reading in a pre-determined location information data that corresponds to the inspection data list,
the mobile computing device receiving site inspection data,
the mobile computing device issuing a site data message containing the location information data and the site inspection data to the Inspection server computer, and
the Inspection server computer receiving the site data message containing the location information data and the site inspection data, and
wherein the inspection service is provided by a cloud computing system.

19. The method according to claim 18, wherein the alert service further comprises
the mobile computing device reading in a location information data at the client terminal computer that has issued the user feedback message that indicates a user alert,
the mobile computing device issuing a site data message containing the location information data, and
the Inspection server computer receiving the site data message containing the location information data.

20. The method according to claim 18, wherein the alert service further comprises
the client terminal computer receiving phone identity data relating to the mobile computing device that has received the alert message,
the client terminal computer issuing a data message containing the phone identity data, and
the Inspection server computer receiving the data message containing the phone identity data.

21-24. (canceled)

25. A system for supporting facilities management services, the system comprising:
at least one client terminal computer comprising a display device, at least one corresponding tactile input device, and a client wireless communication module,
at least one mobile computing device,
an Inspection server computer wireless communication module for communicating with the at least one client terminal computer and for communicating with an Inspection server computer, and
an Inspection server computer wireless phone module for communicating with the at least one mobile computing device and for communicating with the Inspection server computer,
wherein the system provides a user feedback data acquisition mode, an alert mode, and a site inspection mode, such that
in the user feedback data acquisition mode,
the client terminal computer provides a pre-determined set of user feedback messages on the display device, and upon receiving a user input into the tactile input device, the client terminal computer issues a pre-determined user feedback message over the client wireless communication module, and
the Inspection server computer wireless communication module receives the predetermined user feedback message from the at least one client terminal computer and transmits the pre-determined user feedback message to the Inspection server computer,
in the alert mode,
the Inspection server computer wireless phone module receives an alert from the Inspection server computer and issues an alert message for instructing a supervisor to proceed to the at least one client terminal computer that has issued the respective user feedback message that indicates a user alert, and
in the inspection mode,
the Inspection server computer wireless phone module receives an inspection data list from the Inspection server computer and issues the inspection data list,
the mobile computing device reads in pre-determined location information data that corresponds to the inspection data list,
the mobile computing device receives site inspection data,
the mobile computing device issues a site data message containing the location information data and the site inspection data to the Inspection server computer wireless phone module, and
the Inspection server computer wireless phone module receives the site data message containing the location information data and the site inspection data and transmits the site data message containing the location information data and the site inspection data to the Inspection server computer.

26. The system according to claim 25, wherein in the alert mode,
the mobile computing device reads in a location information data at the least one client terminal computer that has issued the respective user feedback message that indicates a user alert,
the mobile computing device issues a site data message containing the location information data, and
the Inspection server computer wireless phone module receives the site data message containing the location information data and transmits the site data message containing the location information data to the Inspection server computer.

27-42. (canceled)
